(19) United States
(12) Patent Application Publication
(10) Pub. No.: US 2026/0080850 A1
(43) Pub. Date: Mar. 19, 2026

(54) Sensor Device, Mute Device for Wind Instrument, and Method for Computing Radiated Sound Waveform

(71) Applicant: YAMAHA CORPORATION, Hamamatsu-shi (JP)

(72) Inventor: Hideyuki MASUDA, Hamamatsu-shi (JP)

(21) Appl. No.: 19/395,012

(22) Filed: Nov. 20, 2025

Related U.S. Application Data
(63) Continuation of application No. PCT/JP2024/019313, filed on May 27, 2024.

(30) Foreign Application Priority Data
Jun. 19, 2023 (JP) 2023-099941

(51) Int. Cl. G10H 1/00; G01L 9/08; G10D 9/035; G10D 9/06; G10H 3/14

(52) U.S. Cl. CPC G10H 1/0008; G01L 9/08; G10D 9/035; G10D 9/06; G10H 3/143; G10H 2210/066; G10H 2220/525

(57) ABSTRACT

A sensor device includes a source and a first sensor arrangement. The source generates a wave traveling within a tube of a wind instrument. The first sensor arrangement includes a plurality of sensors that sense the wave. The source and the first sensor arrangement are arranged within the tube such that the plurality of sensors are each positioned at a distance from one another in the longitudinal direction of the tube.

### CROSS-REFERENCE TO RELATED APPLICATIONS

The present application is a continuation application of International Application No. PCT/JP2024/019313, filed May 27, 2024, which claims priority to Japanese Patent Application No. 2023-099941, filed Jun. 19, 2023. The contents of these applications are incorporated herein by reference in their entirety.

### BACKGROUND

The present disclosure relates to a sensor device, a mute device for a wind instrument, and a method for computing a radiated sound waveform.

JP 2018-521367A discloses a system for representing sounds of a reed instrument. The system includes a speaker arranged to deliver sound to an air chamber of the reed instrument, a microphone that receives sound in the air chamber, and a processing unit that receives a measurement signal from the microphone. The processing unit generates from the measurement signal an output signal indicative of which musical note is being played by the reed instrument. The system includes additionally a pressure sensor that sends to the processing unit a signal which indicates when a user is blowing into the reed instrument.

### SUMMARY

One aspect is a sensor device that includes a source and a first sensor arrangement. The source is configured to generate a wave traveling within a tube of a wind instrument. The first sensor arrangement includes a plurality of sensors configured to sense the wave. The source and the first sensor arrangement are configured to be arranged within the tube such that the plurality of sensors are each positioned at a distance from one another in the longitudinal direction of the tube.

Another aspect is a sensor device that includes a first actuator, a first sensor arrangement, and a first mount. The first actuator is configured to vibrate air within the tube of a wind instrument to generate a sound wave. The first sensor arrangement includes a plurality of sensors configured to sense the sound wave. The first mount is configured to dispose the first actuator and the first sensor arrangement within the tube.

Another aspect is a mute device for a wind instrument. The device includes a sensor device according to one of the aforementioned aspects and a blocker device. The blocker device is configured to be disposed between the tube and a mouthpiece for the wind instrument to block air from the mouthpiece from flowing into the tube.

Another aspect is a method for computing a radiated sound waveform. The method includes estimating a tube shape model representing the shape of the tube of a wind instrument based on standing wave information pertaining to the distribution of a standing wave appearing within the tube of the wind instrument. The method also includes computing a waveform pertaining to a radiated sound from the wind instrument based on the estimated tube shape model and blowing pressure information pertaining to the blowing pressure of a player who plays the wind instrument.

Another aspect is a method for computing a radiated sound waveform. The method includes estimating a tube shape model representing the shape of the tube of a wind instrument based on progressive wave information pertaining to the distribution of a progressive wave appearing within the tube of the wind instrument. The method also includes computing a waveform pertaining to a radiated sound from the wind instrument based on the estimated tube shape model and blowing pressure information pertaining to the blowing pressure of a player who plays the wind instrument.

Another aspect is a method for computing a radiated sound waveform. The method includes estimating the shape of the oral cavity of a player who plays a wind instrument having an operator based on vibrations information pertaining to the vibrations of air in the oral cavity. The method also includes computing a waveform pertaining to a radiated sound from the wind instrument based on manipulation information indicating the manipulation of the operator by the player, the estimated shape of the oral cavity, and blowing pressure information pertaining to the blowing pressure of the player.

A more complete appreciation of the present disclosure and many of the attendant advantages thereof will be readily obtained as the same becomes better understood by reference to the following detailed description when considered in connection with the following figures, in which:

### BRIEF DESCRIPTION OF THE DRAWINGS

FIG. 1 is a cross-sectional view of a clarinet and a mute device for the wind instrument along the central axis of the same, in accordance with an embodiment of the present disclosure;

FIG. 2 is a plan view of the clarinet and the mute device for the wind instrument;

FIG. 3 is a front elevational view of the clarinet and the mute device for the wind instrument;

FIG. 4 is a block diagram of an example configuration of a sensor device of the mute device for the wind instrument;

FIG. 5 shows an example tone hole open/closed pattern of the clarinet of FIG. 1;

FIG. 6 is a cross-sectional view of a mouthpiece and a reed shown in FIG. 1;

FIG. 7 shows the shape of a vibratory part of the reed;

FIG. 8 illustrates an incident wave and a reflected wave in an oral cavity with a simple shape;

FIG. 9 illustrates an incident wave and a reflected wave in an oral cavity with a more complex shape;

FIG. 10 schematically illustrates the incident wave, the reflected wave, and a transmitted wave in the oral cavity with the more complex shape;

FIG. 11 is a block diagram of the configuration of a physical model-based sound source module;

FIG. 12 shows the configuration of a reed dynamic characteristics block;

FIG. 13 is a block diagram of an example configuration of a sensor device, in accordance with a different embodiment of the present disclosure; and

FIG. 14 is a cross-sectional view of a simple physical model, in accordance with the different embodiment.

### DETAILED DESCRIPTION

The present specification is applicable to a sensor device, a mute device for a wind instrument, and a method for computing a radiated sound waveform.

The embodiments will now be described with reference to the accompanying drawings, wherein like reference numerals designate corresponding or identical elements throughout the various drawings. The embodiments presented below serve as illustrative examples of the present disclosure and are not intended to limit the scope of the present disclosure. In the accompanying drawings referenced in the embodiments, similar reference numerals, characters, or symbols may be used to indicate corresponding or identical elements. For example, to distinguish like elements, “A” may be appended to a reference numeral and “B” may be appended to the same reference numeral.

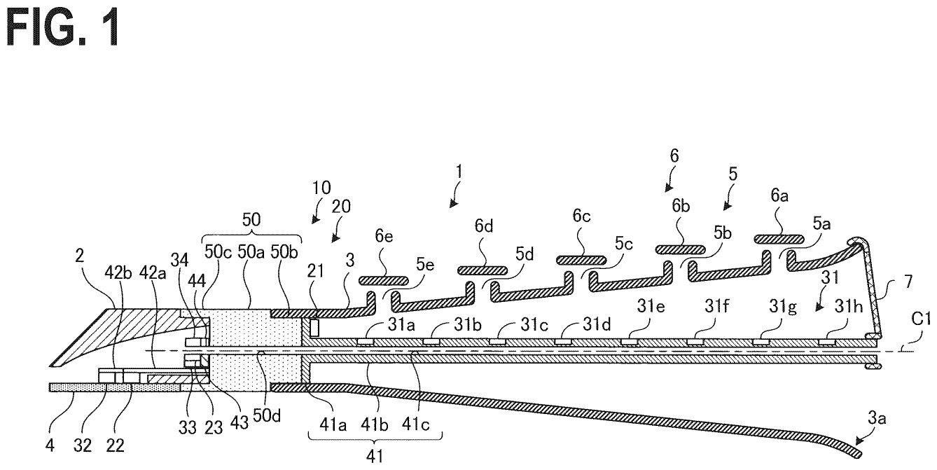

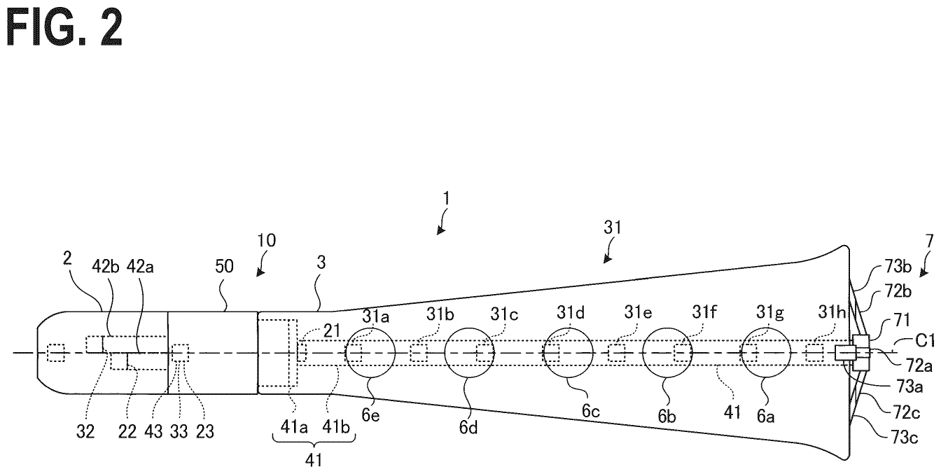

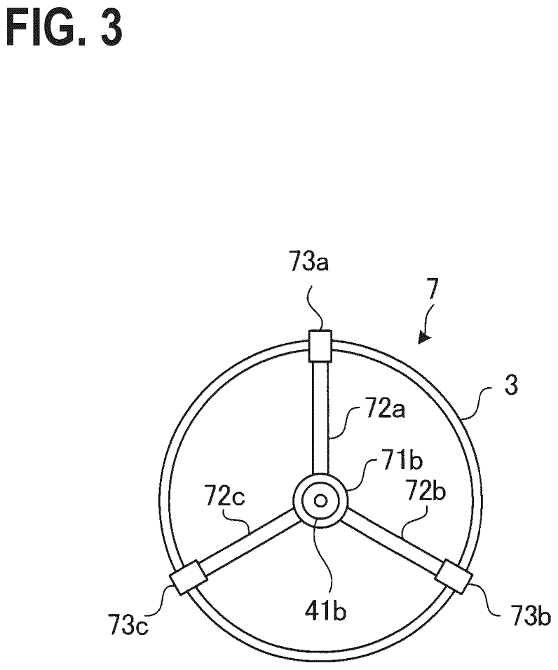

FIG. 1 is a cross-sectional view of a clarinet and a mute device for the wind instrument along the central axis of the same, in accordance with an embodiment of the present disclosure. FIG. 2 is a plan view of the clarinet and the mute device for the wind instrument. FIG. 3 is a front elevational view of the clarinet and the mute device for the wind instrument. FIG. 1 is a view of a clarinet and a mute device for a wind instrument as viewed from the horizontal direction, and FIG. 2 is a view of the clarinet and the mute device as viewed from above.

The mute device 10 for the wind instrument in the form of the clarinet 1 is used by being attached between the tube 3 of the clarinet 1 and a mouthpiece 2 for the clarinet 1. In addition to these mouthpiece 2 and tube 3, the clarinet 1 includes a reed 4. The mouthpiece 2 in FIG. 1 has such an orientation that the lower side of the sheet of the figure corresponds to the underside of the mouthpiece 2.

The tube 3 has a plurality of open tone holes 5a to 5e in the longitudinal direction of the tube 3. A plurality of operators 6a to 6e are associated with the plurality of tone holes 5a to 5e. A player can manipulate each of the operators 6a to 6e to control the open or closed state of a respective one of the tone holes 5a to 5e. It should be noted that, while the schematic configuration illustrated in FIG. 1 features five tone holes and five operators, a real clarinet can have different numbers of the tone holes and operators.

The mute device 10 for the wind instrument includes a sensor device 20 and a blocker device 50.

The sensor device 20 includes a first actuator 21 serving as a source, a first sensor arrangement 31, a first mount 41, a second actuator 22, a second sensor arrangement 32, a second mount 42, a third actuator 23, a third sensor arrangement 33, a third mount 43, a fourth sensor arrangement 34, and a fourth mount 44.

The first mount 41 is configured to dispose the first actuator 21 and the first sensor arrangement 31 within the tube 3. The first mount 41 is in the form of a cylindrical member extending in the longitudinal direction of the tube 3 with one end having a flanged feature. The one end of the first mount 41 is configured to be positioned near the inlet of the tube 3. The other end of the first mount 41 extends out of the tube 3 via the outlet of the tube 3. The other end of the first mount 41 is fastened to the tube 3 with the aid of a fastener 7. While the first mount 41 and the blocker device 50 are made as separate pieces in FIG. 1, the first mount 41 and the blocker device 50 may instead be formed as a one-piece construction.

As illustrated in FIG. 3, the fastener 7 includes a central element 71, three arms 72a, 72b, and 72c, and three anchors 73a, 73b, and 73c. The central element 71 is mounted to the other end of the first mount 41. In one example illustrated in FIG. 3, the central element 71 is annularly shaped so that the other end of the first mount 41 can be fitted to the central element 71.

The three arms 72a, 72b, and 72c extend radially from the central element 71. The three arms 72a, 72b, and 72c are flexible. The three arms 72a, 72b, and 72c have free ends to which the three anchors 73a, 73b, and 73c are respectively secured. Each of the three anchors 73a, 73b, and 73c is designed to latchingly engage one end of the tube 3. In this way, the other end of the first mount 41 is fastened to the tube 3 without causing any wobble, thereby fixing the first mount 41 in position relative to the tube 3. It should be noted that the other end of the first mount 41 may or may not extend out of the tube 3, as long as the same end can be fastened to the tube 3 without causing any wobble.

The first actuator 21 is configured to generate a wave in an audible band and traveling within the tube 3. A wave in an audible band will hereinafter be referred to a sound wave. The first actuator 21 is located at a flanged part 41a of the first mount 41. Examples of the first actuator 21 include a speaker, a horn driver, and a piezoelectric element. Thus, the first actuator 21 is configured to generate a sound wave to vibrate air within the tube 3. It should be noted that the first actuator 21 may alternatively be located at a part of the first mount 41 near the outlet of the tube 3.

The first sensor arrangement 31 is located at a cylindrical part 41b of the first mount 41. The first sensor arrangement 31 includes eight sensors 31a, 31b, 31c, 31d, 31e, 31f, 31g, and 31h. Examples of each of the eight sensors 31a to 31h include a microphone and a pressure transducer. It should be noted that the first sensor arrangement 31 in FIG. 1 may include more or fewer than eight sensors instead.

The eight sensors 31a to 31h are configured to be all positioned at a distance from one another in the longitudinal direction of the tube 3. In particular, the eight sensors 31a to 31h in this example are configured to be all positioned at regular intervals in parallel to the central axis C1 of the tube 3. While the eight sensors 31a to 31h are preferably configured to be all positioned at a distance of 5-15 cm, these values merely represent some of the non-limiting examples of the distance. Moreover, the sensors 31a to 31h are preferably configured to be each positioned along the central axis C1.

The second mount 42 is configured to dispose the second actuator 22 and the second sensor arrangement 32 on the reed 4. The second mount 42 includes a first cantilever 42a and a second cantilever 42b. One end of the first cantilever 42a is fixed to the blocker device 50. The other end of the first cantilever 42a is provided with the second actuator 22. The first cantilever 42a urges the second actuator 22 against the reed 4.

One end of the second cantilever 42b is fixed to the blocker device 50. The other end of the second cantilever 42b is provided with the second sensor arrangement 32. The second cantilever 42b urges the second sensor arrangement 32 against the reed 4.

The second actuator 22 is configured to cause the reed 4 to vibrate. The second actuator 22 is in the form of an actuator that utilizes a piezoelectric element. The second actuator 22 can exploit an inverse piezoelectric effect of the piezoelectric element to displace the reed 4. For instance, if a sinusoidal voltage is applied to the piezoelectric element of the second actuator 22, the reed 4 can be caused to vibrate at the frequency of the sinusoidal wave.

The second actuator 22 is configured to create vibrations having a frequency component at or above a minimum pitch that can be emitted by the clarinet 1. For example, the vibrations may be created by applying to the piezoelectric element a voltage waveform obtained by subjecting a random noise waveform to a high-pass filter, which is configured to minimize those frequency components of the waveform below the minimum pitch that can be emitted by the clarinet 1. Alternatively or additionally, the vibrations may be created by applying to the piezoelectric element a sinusoidal voltage waveform that is swept at or above the minimum pitch.

The second sensor arrangement 32 includes at least one sensor to sense the vibrations of the reed 4. The second sensor arrangement 32 is in the form of a contact vibration sensor. The second sensor arrangement 32 is configured to determine the displacement, the velocity of the displacement, and the acceleration of the displacement of the reed 4. The vibration sensor is in the form of a sensor that utilizes a piezoelectric element. The vibration sensor exploits a piezoelectric effect of the piezoelectric element to convert a pressure change resulting from the vibrations of the reed 4 into an electrical signal. It should be understood that the second sensor arrangement 32 may alternatively or additionally be in the form of a MEMS (or micro electro mechanical systems)-based acceleration sensor, an acceleration sensor that utilizes an optical fiber, or any other sensor that suits the purpose. As an alternative or in addition to the contact vibration sensor, a non-contact sensor may be used to sense the vibrations of the reed 4. For instance, a photocoupler may be used to sense the vibrations of the reed 4.

The third mount 43 is configured to dispose the third actuator 23 and the third sensor arrangement 33 within the mouthpiece 2.

The third actuator 23 is configured to vibrate air in the oral cavity of the player. Examples of the third actuator 23 include a speaker, a horn driver, and a piezoelectric element.

The third sensor arrangement 33 is configured to detect vibration of air in the oral cavity of the player. Examples of the third sensor arrangement 33 include a microphone and a pressure transducer. The pressure transducer may detect a change in resistance of an isotropic conductor or utilize the piezoelectric effect of a piezoelectric element. Alternatively or additionally, the third sensor arrangement 33 may include an acceleration sensor.

The fourth mount 44 is configured to dispose the fourth sensor arrangement 34 within the mouthpiece 2. The fourth sensor arrangement 34 includes at least one sensor. The fourth sensor arrangement 34 is configured to sense the blowing pressure of the player and convert the sensed blowing pressure to an electrical signal. The converted electrical signal will hereinafter be referred to as a blowing pressure signal. Examples of the fourth sensor arrangement 34 include a gas pressure sensor, an air velocity sensor, and a flow velocity sensor.

The blocker device 50 is configured to be disposed between the tube 3 and the mouthpiece 2 for the clarinet 1. The blocker device 50 is in the form of a cylindrical member. The blocker device 50 includes a main body part 50a, a smaller diameter part 50b, and an annular part 50c. The smaller diameter part 50b has an outer diameter that is equal to or smaller than the inner diameter of the tube 3. The smaller diameter part 50b is fitted to the tube 3. The annular part 50c is annularly shaped with an inner diameter equal to or smaller than the outer diameter of the mouthpiece 2. The annular part 50c is fitted to the mouthpiece 2. It should be noted that, while the blocker device 50 is formed of the main body part 50a, the smaller diameter part 50b, and the annular part 50c to provide a configuration advantageously adapted to the shape of the clarinet 1, this configuration may not be appropriate for other reed instruments. Appropriate changes can be made to the shape of the blocker device 50 so as to adapt the same to the shape of a reed instrument of interest.

The blocker device 50 and the first mount 41 are configured to meet at an interface between a surface of the blocker device 50 on the side of the tube 3, that is, the bottom surface of the smaller diameter part 50b, and the end face of the flanged part 41a of the first mount 41. The blocker device 50 has an internal wall surface 50d that joins continuously with no step to the internal wall surface 41c of the first mount 41. The blocker device 50 is configured to block air from the mouthpiece 2 from flowing into the tube 3. Thus, the internal volume of the mouthpiece 2 does not communicate with the internal volume of the tube 3.

Meanwhile, the internal volume of the mouthpiece 2 communicates with the internal volume of the first mount 41. As described, the internal volume of the first mount 41 is defined by the internal wall surface 41c. Accordingly, air flowing in from the mouthpiece 2 passes through the interior of the first mount 41 and is released to the outside through the other end of the first mount 41. Thus, air blown by the player of the clarinet 1 into the mouthpiece 2 is prevented from flowing into the tube 3 and therefore does not contribute to the generation of vibrations of air within the tube 3. In this way, the mute device 10 for the wind instrument acts as a muting tool for the clarinet 1. It should be understood that the main body part 50a may have an open hole for escaping air. When the main body part 50a has such an air relief hole, air blown by the player into the mouthpiece 2 flows out through the air relief hole and is therefore prevented from flowing into the tube 3. Further, by providing an air relief hole in the main body part 50a, the internal volume of the first mount 41 can even be omitted or filled.

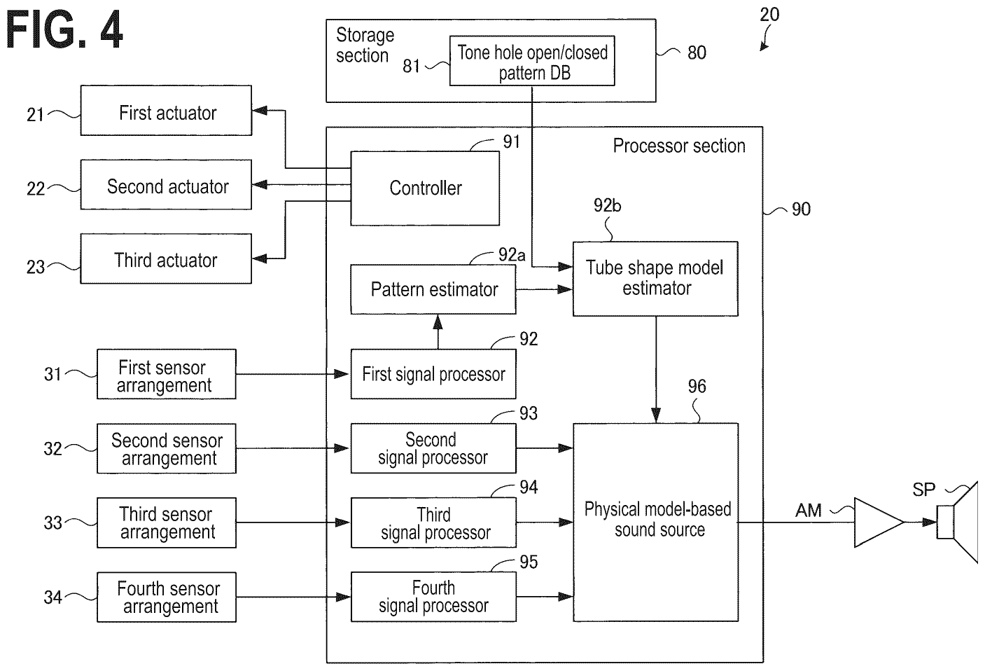

Now, referring to FIG. 4, the configuration of the sensor device of the mute device 10 for the wind instrument in accordance with an embodiment of the present disclosure will be described.

FIG. 4 is a block diagram of an example configuration of the sensor device of the mute device 10 for the wind instrument, in accordance with the embodiment. The sensor device 20 includes the first actuator 21, the second actuator 22, the third actuator 23, the first sensor arrangement 31, the second sensor arrangement 32, the third sensor arrangement 33, the fourth sensor arrangement 34, a storage section 80, and a processor section 90.

The storage section 80 is in the form of a computer-readable storage medium (for example, a non-transitory computer-readable storage medium). The storage section 80 includes a non-volatile memory and a volatile memory. Examples of the non-volatile memory include a ROM (or read-only memory), an EPROM (or erasable programmable read-only memory), and an EEPROM (or electrically erasable programmable read-only memory). Examples of the volatile memory include a RAM (or random access memory).

A program p1 and various information are stored in the storage section 80. The program p1 defines the operation of the sensor device 20. The program p1 stored in the storage section 80 may be retrieved from a storage device in a server (not shown). In this case, the storage device in the server constitutes one of the non-limiting examples of the computer-readable storage medium.

The processor section 90 includes one or more CPUs (or central processing units). The one or more CPUs constitute one of the non-limiting examples of one or more processors. Each of the processor section, the processor(s), and the CPU(s) constitutes one of the non-limiting examples of a computer.

The processor section 90 loads the program p1 from the storage section 80. By executing the program p1, the processor section 90 implements the functions of a controller 91, a first signal processor module 92, a pattern estimator module 92a, a tube shape model estimator module 92b, a second signal processor module 93, a third signal processor module 94, a fourth signal processor module 95, and a physical model-based sound source module 96. One or more of the controller 91, the first signal processor module 92, the pattern estimator module 92a, the tube shape model estimator module 92b, the second signal processor module 93, the third signal processor module 94, the fourth signal processor module 95, and the physical model-based sound source module 96 may be implemented with a DSP (or digital signal processor), an ASIC (or application-specific integrated circuit), a PLD (or programmable logic device), a FPGA (or field programmable gate array), or any other such circuit.

The controller 91 controls the first actuator 21, the second actuator 22, and the third actuator 23.

The first signal processor module 92 is formed of an amplifier circuit and a sample and hold circuit. The first signal processor module 92 acquires a sensing signal that is output from each of the eight sensors 31a to 31h of the first sensor arrangement 31 while the first actuator 21 is being activated. The first signal processor module 92 extracts standing wave information pertaining to the distribution of a standing wave appearing within the tube 3 based on the acquired sensing signals and produces an output of the extracted standing wave information. It should be understood that a sinusoidal waveform swept in an audible band may be used as an input to the first actuator 21 when the first actuator 21 is being activated. Moreover, the waveform provided to the first actuator 21 may be swept on a semitone basis.

The standing wave information can be extracted in the following way. Firstly, the controller 91 causes the first actuator 21 to vibrate at one or more audible frequencies. The vibrations of the first actuator 21 cause air within the tube 3 to vibrate, resulting in the appearance of a standing wave within the tube 3 as a function of the open or closed states of the tone holes 5a to 5e. The standing wave is a resultant wave of a progressive wave and a reflected wave. The progressive wave propagates from the inlet of the tube 3 towards the outlet of the tube 3, and the progressive wave is reflected at the outlet of the tube 3 and generates a reflected wave, which propagates back from the outlet of the tube 3 towards the inlet of the tube 3.

Each of the sensors 31a to 31h is configured to sense the sound pressure of the standing wave at the location of a respective one of the sensors 31a to 31h and produce an output of the sensed sound pressure. Each of the sensors 31a to 31h is configured to sense a superposition of the progressive wave and the reflected wave as the standing wave. When each of the sensors 31a to 31h is a microphone, the sensors 31a to 31h are each configured to produce an output of a sound pressure level that corresponds to the sensed amplitude intensity. While the sound pressure levels that are output from the individual sensors 31a to 31h change sinusoidally, the individual patterns of change of the output sound pressure levels can vary differently, depending on the position of each of the sensors 31a to 31h.

The maximum sound pressure amplitude is sensed by sensors located at antinodes of the standing wave, while the minimum sound pressure amplitude is sensed by sensors located at nodes of the standing wave. The distribution of change of the individual amplitudes of the output sound pressure levels within the tube 3 corresponds to the sound pressure distribution of the standing wave appearing within the tube 3.

Thus, the first signal processor module 92 acquires the sinusoidally changing sound pressure levels that are output individually from the respective sensors 31a to 31h. The amplifier circuit of the first signal processor module 92 amplifies each of the output sound pressure levels thus acquired. The first signal processor module 92 uses the sample and hold circuit to determine, from each of the output sound pressure levels thus amplified, the amplified peak value of a respective one of the output sound pressure levels.

The individual peak values thus determined represent the sound pressure distribution of the standing wave at the individual sensor locations. Hence, the first signal processor module 92 can estimate the sound pressure distribution of the standing wave within the tube 3 based on the amplitudes of the sound pressure levels as sensed by the individual sensors. The first signal processor module 92 feeds the output of the amplitude information on the sound pressure levels at the individual sensors 31a to 31h to the pattern estimator module 92a. As such, the standing wave information is based on information output from the plurality of sensors 31a to 31h.

The pattern estimator module 92a estimates a tone hole open/closed pattern based on the amplitude information on the sound pressure levels at the individual sensors 31a to 31h.

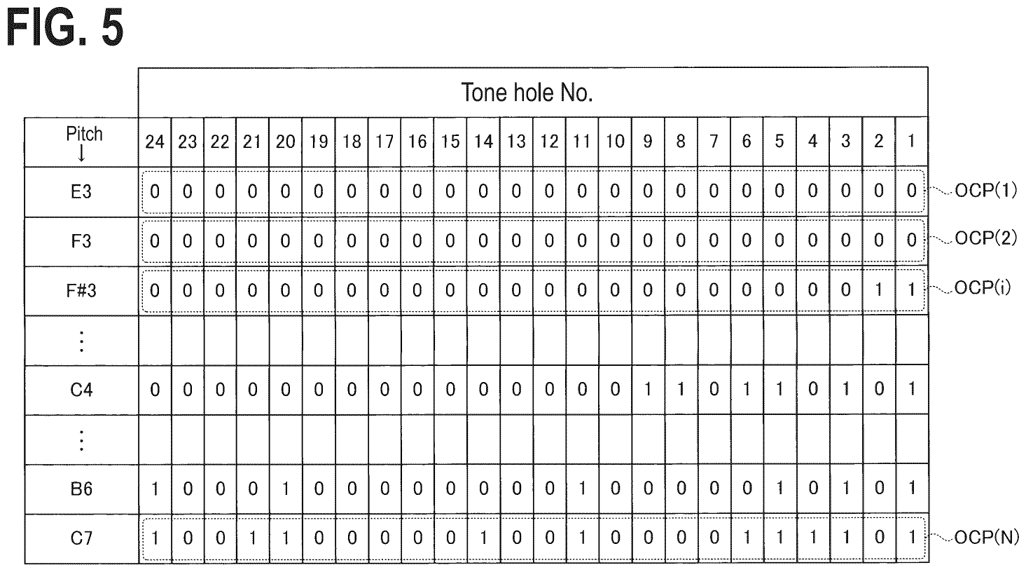

FIG. 5 shows an example tone hole open/closed pattern of the clarinet 1 of FIG. 1. In FIG. 5, prescribed pitches i (where i=1, 2, . . . , N) of the clarinet 1 are associated with the respective open or closed states of the tone holes of the clarinet 1. The tone holes are assigned with numbers sequentially according to the distance from the outlet of the tune 3 such that the tone hole closest to the outlet of the tube 3 is assigned No. 1 and the tone hole farthest from the outlet of the tube 3 is assigned No. 24. The open or closed state of each of the tone holes is indicated with either 0 or 1. In this particular context, “0” represents the closed state and “1” represents the open state of a tone hole. The tone hole open/closed pattern of the clarinet 1 is a pattern that lists the open or closed states of all of the tone holes in the order of the numbers assigned to the tone holes, and a tone hole open/closed pattern at a given pitch i is denoted as OCP(i). A tone hole open/closed pattern OCP(i) takes a discrete value.

Referring to FIG. 5, the tone hole open/closed pattern OCP(1) has a value corresponding to the pitch “E3”. When sound with the pitch “E3” is generated, all of the tone holes are in the closed states, meaning that all of the tone holes assigned with the different tone hole numbers are associated with the value of “0” in the tone hole open/closed pattern OCP(1). The tone hole open/closed pattern OCP(i) is set to a value corresponding to the pitch “F #3”. Then, generation of sound with the pitch “F #3” means that the tone holes assigned with the tone hole numbers No. 1 and No. 2 are associated with the value of “1” while the tone holes assigned with the tone hole numbers No. 3 to No. 24 are associated with the value of “0” according to the tone hole open/closed pattern OCP(i).

The tone hole open/closed pattern OCP(i) provides information pertaining to the open or closed status of each of the plurality of tone holes of the clarinet 1. Thus, the tone hole open/closed pattern OCP(i) can also be considered as providing information pertaining to the fingering condition of the player of the clarinet 1. Now, a classification-based machine learning process for the tone hole open/closed pattern OCP(i) will be described below.

In the instant embodiment, a classification-based supervised learning is carried out with support vector machine. Input data for the support vector machine is acquired as follows: the first sensor arrangement 31 is exposed to white noise applied for a certain duration per each tone hole open/closed pattern OCP(i) realized by a corresponding fingering on the clarinet 1. For instance, the white noise to which the first sensor arrangement 31 is exposed may be emitted by the first actuator 21, another actuator or speaker, or the like. When the plurality of sensors of the first sensor arrangement 31 consist of m microphones, time averages of the individual sound pressure levels output from the m microphones are calculated. For each tone hole open/closed pattern, a tonal of n tries are conducted to calculate n time averages of the individual output sound pressure levels.

The sound pressure level output from a first one of the microphones, the sound pressure level output from a second one of the microphones, . . . , and the sound pressure level output from a m-th one of the microphones in the first try are expressed, respectively, as L1(1) decibel, L2(1) decibel, . . . , and Lm(1) decibel. The sound pressure level output from the first one of the microphones, the sound pressure level output from the second one of the microphones, . . . , and the sound pressure level output from the m-th one of the microphones in the n-th try are expressed, respectively, as L1(n) decibel, L2(n) decibel, . . . , and Lm(n) decibel.

The outcome of the first try I1 (L1(1), L2(1), . . . , Lm(1)), the outcome of the second try I2 (L1(2), L2(2), . . . , Lm(2)), . . . , and the outcome of the n-th try In (L1(n), L2(n), . . . , Lm(n)) are provided as input data for the support vector machine. The outcomes I1, I2, . . . , and In will hereinafter be denoted as the standing wave sound pressure distribution information. In addition, the tone hole open/closed pattern OCP(i) is provided as output data for the support vector machine.

A support vector machine model-based machine learning apparatus uses the input data in the form of the standing wave sound pressure distribution information I1 to In as an input to the support vector machine model to train the support vector machine model to learn the correlation between the input data in the form of the standing wave sound pressure distribution information I1 to In and the output data in the form of the tone hole open/closed pattern OCP(i).

The machine learning apparatus ends the training process upon determining that a prescribed condition for completing the training has been met and stores the support vector machine model as of this point in the storage section 80 as a trained model. For example, the prescribed condition for completing the training is that the number of iterations of the training process with the abovementioned set of steps reaches a predefined threshold.

In this way, the relationship between the combination of the sound pressure levels output from the m microphones and the tone hole open/closed pattern OCP(i) is learned.

The pattern estimator module 92a feeds an output of the estimated tone hole open/closed pattern to the tube shape model estimator module 92b. The pattern estimator module 92a contains the trained support vector machine. Thus, the pattern estimator module 92a receives, as an input, the amplitude information on the sinusoidal signal at the individual sensors of the first sensor arrangement 31, that is, the combination of the sound pressure levels output by the individual sensors, to predict a corresponding tone hole open/closed pattern OCP(i).

The tube shape model estimator module 92b receives, as an input, the estimated tone hole open/closed pattern from the pattern estimator module 92a. The tube shape model estimator module 92b refers to a tone hole open/closed pattern database 81 to estimate a tube shape model based on the input tone hole open/closed pattern and the tone hole open/closed pattern database 81. The tube shape model estimator module 92b feeds an output of the estimated tube shape model to the physical model-based sound source module 96.

The second signal processor module 93 computes reed resonant characteristics information based on vibrations information on the reed 4 as input from the second sensor arrangement 32 and outputs the reed resonant characteristics information to the physical model-based sound source module 96. More particularly, the controller 91 energizes the second actuator 22, which causes the reed 4 to vibrate. Then, the second signal processor module 93 acquires a waveform pertaining to the displacement of the reed 4 from the second sensor arrangement 32, as the vibrations information on the reed 4. Thus, the second signal processor module 93 can also be considered as a reed state estimator module configured to estimate the state of change of the shape of the reed 4 based on the sensing result of the second sensor arrangement 32.

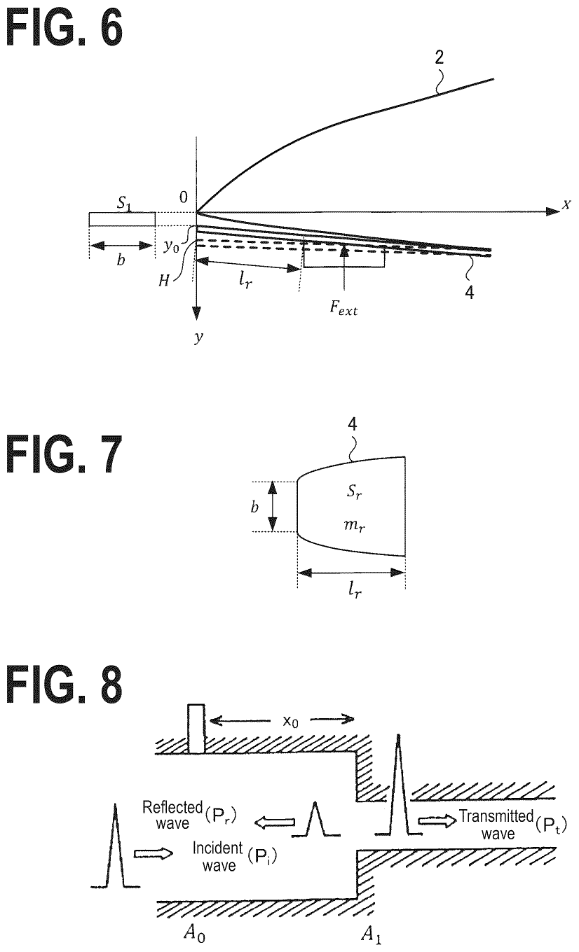

FIG. 6 is a cross-sectional view of the mouthpiece 2 and the reed 4. FIG. 7 shows the shape of a vibratory part of the reed 4. Referring to FIG. 6, the x-axis represents an axis parallel to the axis of the mouthpiece 2 and passing through a point O of origin, which indicates the tip end of the mouthpiece 2. In other words, the x-axis extends parallel to the central axis C1 of the tube 3 in the coupled state of the mouthpiece 2 and the tube 3. The y-axis passes through the point O of origin and extends along the extension of a tip opening. Hence, the x-axis and the y-axis run perpendicular to each other. The positive direction of the y-axis is oriented downwards in FIG. 6 and, thus, corresponds to a direction in which the reed 4 is displaced away from the mouthpiece 2 when the reed 4 vibrates.

Referring to FIG. 7, Ir represents the effective facing length of the reed 4, that is, the length of a part of the reed 4, which effectively contributes to vibrations. b represents the width of the tip end portion of the reed 4. Fext in FIG. 6 represents the external force in the y-axis direction exerted on the reed 4 by the player through the player's lips. H represents the y-axis coordinates of the tip end portion of the reed 4 when the external force Fext is zero. y0 represents the y-axis coordinates of the tip end portion of the reed 4 when the external force Fext is exerted on the reed 4. In the words, y0 represents a static opening degree of the reed 4. S1 represents the area occupied by the gap between the reed 4 and the mouthpiece 2. S1 will hereinafter be referred to as a reed gap area.

mr represents an effective vibratory mass of the reed 4 and, thus, represents the mass of a part of the reed 4 that vibrates. mr will hereinafter be referred to as an effective reed vibratory mass. Sr represents an effective area of a part of the reed 4 that vibrates. Sr will hereinafter be referred to as an effective reed vibratory area. μr represents an effective mass of the reed 4 per unit area of the reed 4. μr will hereinafter be referred to as an effective reed unit mass. H represents the y-axis coordinates of the tip end portion of the reed 4 when the external force Fext is zero. Therefore, H denotes the initial value of the static opening degree of the reed 4.

The second signal processor module 93 computes the resonant characteristics of the reed based on a waveform related to the acquired displacement of the reed 4 along the y-axis and outputs the resonant characteristics of the reed as the reed resonant characteristics information. The reed resonant characteristics information contains the resonant frequency fr of the reed 4 and the opening degree y0 of the reed 4 along the y-axis.

Also, the second signal processor module 93 subjects the acquired waveform related to the displacement of the reed 4 along the y-axis to a LPF to compute the static displacement of the reed 4 at the location of contact between the reed 4 and the second sensor arrangement 32. Further, the second signal processor module 93 computes the opening degree y0 of the reed 4 at the tip end portion based on the static displacement at the location of contact between the reed 4 and the second sensor arrangement 32.

It should be understood that the displacement of the reed 4 at the tip end portion may be sensed with a photocoupler. In this scenario, the sensing signal from the photocoupler may be low-pass filtered, for example, to obtain the static opening degree of the reed at the tip end portion. In this way, the displacement of the reed 4 at the tip end portion can be determined with enhanced accuracy.

The third signal processor module 94 estimates in real time the shape of the oral cavity of the player based on a reflection from the interior of the oral cavity of the player and feeds an output of information pertaining to the estimated shape of the oral cavity to the physical model-based sound source module 96 as oral cavity shape information. Thus, the third signal processor module 94 can also be considered to be an oral cavity shape estimator module configured to estimate the shape of the oral cavity based on the sensing result of the third sensor arrangement 33.

More particularly, the third signal processor module 94 acquires from the third sensor arrangement 33 a sound pressure signal, which is sensed by the third sensor arrangement 33 when the controller 91 causes the third actuator 23 to vibrate while the player holds the mouthpiece 2 in the player's mouth. Here, the sound pressure signal obtained by the third signal processor module 94 contains a signal of the reflection from the interior of the oral cavity and the interior of the respiratory tract of the player.

The third signal processor module 94 employs, for example, a Ware and Aki algorithm to estimate in real time the shape of the oral cavity. Since the oral cavity adjoins the respiratory tract, the shape of the oral cavity as estimated with the algorithm also contains the shape of the respiratory tract.

FIG. 8 illustrates an incident wave and a reflected wave in an oral cavity with a simple shape. The oral cavity illustrated in FIG. 8 has a cross-sectional area that changes in a stepwise manner from an entrance cross-sectional area A0 at the entrance of the oral cavity to a first cross-sectional area A1 at the point x0. Under the condition that the pressure and the volume flow velocity are conserved before and after the point of change, that is, the point of discontinuity, of cross-sectional area, the reflection coefficient r of sound is calculated according to equation (1) as follows:

$$r = ( {P}_{r} / {P}_{i} ) \times ( {A}_{0} - {A}_{1} ) / ( {A}_{0} + {A}_{1} ) \qquad ( 1 )$$

where Pᵢ indicates an incident wave and Pᵣ indicates a reflected wave.

Now, since the entrance cross-sectional area A0 is known, the first cross-sectional area A1 inside the oral cavity is calculated according to equation (2) as follows:

$${A}_{1} = [ ( {P}_{r} - r \times {P}_{i} ) / ( {P}_{r} + r \times {P}_{i} ) ] \times {A}_{0} \qquad ( 2 )$$

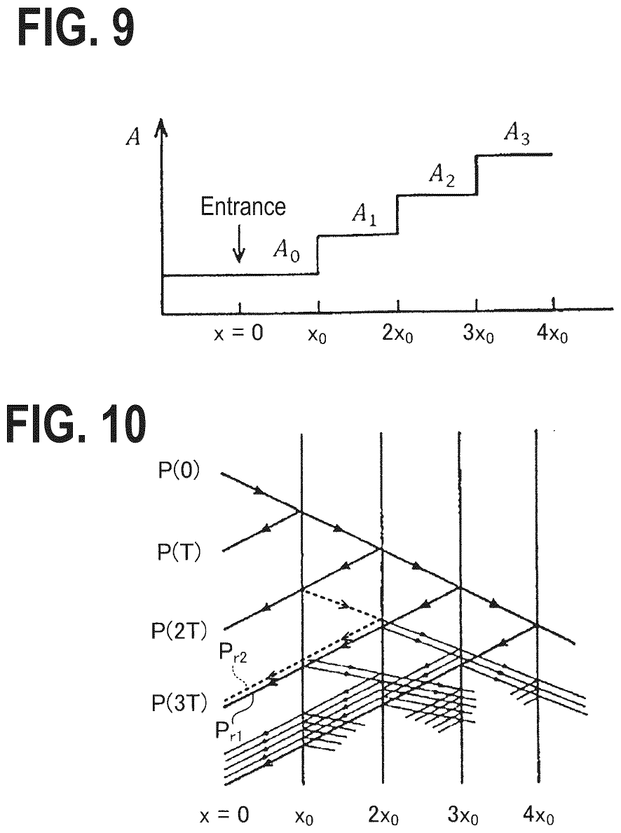

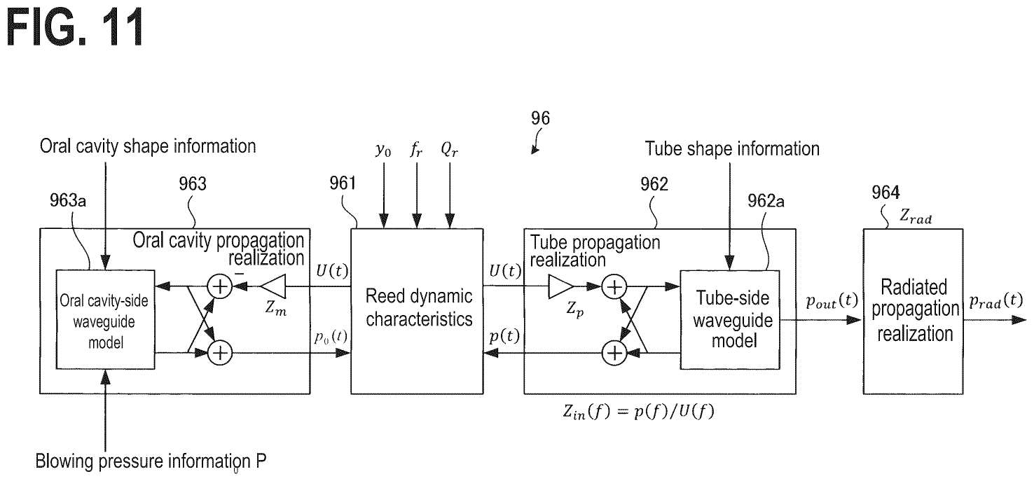

FIG. 9 illustrates an incident wave and a reflected wave in an oral cavity with a more complex shape. In the case of the oral cavity illustrated in FIG. 8, the cross-sectional areas of the oral cavity at the points x0, 2x0, 3 x0, and 4x0 from the entrance of the oral cavity would be expressed as A0, A1, A2, and A3 in this order. FIG. 10 schematically illustrates the incident wave, the reflected wave, and a transmitted wave in the oral cavity with the more complex shape. If the incident wave Pi enters the oral cavity at the time 0, a reflection P(T) of the wave reflected by the cross section at the point x0 is observed at the time T. A reflection P(2T) of the wave reflected by the cross section at the point 2x0 is observed at the time 2T.

In this case, equation (2) can be used to calculate the first cross-sectional area A1 and the second cross-sectional area A2. At the time 3T, a mixed wave of a reflection Pr1 from the cross section at the point 3x0 and a multiple reflection wave Pr2 illustrated with a broken line is observed. Since the multiple reflection wave Pr2 can be calculated from the entrance cross-sectional area A0, the first cross-sectional area A1, and the second cross-sectional area A2, the component corresponding to the multiple reflection wave Pr2 can be separated from the mixed wave. Hence, with the reflection Pr1 isolated from the mixed wave, it is possible to calculate the third cross-sectional area A3 according to equation (2). The Ware and Aki algorithm takes into account the influences from these multiple reflections to estimate the shape of the oral cavity.

The fourth signal processor module 95 acquires from the fourth sensor arrangement 34 a blowing pressure signal detected by the fourth sensor arrangement 34. The fourth signal processor module 95 extracts information pertaining to a blowing pressure based on the acquired blowing pressure signal and outputs the extracted information pertaining to the blowing pressure as blowing pressure information to the physical model-based sound source module 96. Thus, the fourth signal processor module 95 can also be considered to be a blowing pressure information generator module configured to generate the blowing pressure information based on the sensing result of the fourth sensor arrangement 34.

More particularly, the signal detected by the fourth sensor arrangement 34 includes a superposition of the signal resulting from the second actuator 22, the signal resulting from the third actuator 23, and the signal emitted through the oral cavity of the player. While the signal resulting from the second actuator 22 and the signal resulting from the third actuator 23 are largely formed of signals at audible frequencies, the signal emitted through the oral cavity of the player and pertaining to the blowing pressure is formed of signals containing components at frequencies that are lower than the audible frequencies.

To get rid of the signal detected as a result of the second actuator 22 from the signal detected by the fourth sensor arrangement 34, the second actuator 22 can be driven to vibrate the reed 4 with such a minute amplitude that does not interfere with the vibrations of the air of interest. Also, a low-pass filter can be used to eliminate the signal detected as a result of the third actuator 23 from the signal detected by the fourth sensor arrangement 34. Hence, the signal pertaining to the blowing pressure can be isolated from the signal resulting from the second actuator 22 and the signal resulting from the third actuator 23 by using the second actuator 22 to vibrate the reed 4 with a minute amplitude and also applying the low-pass filter. In this way, a blowing pressure signal, which is not affected by resonance in the oral cavity, can be retrieved.

The fourth signal processor module 95 can subject the acquired blowing pressure signal to a low-pass filter to isolate and extract the blowing pressure information.

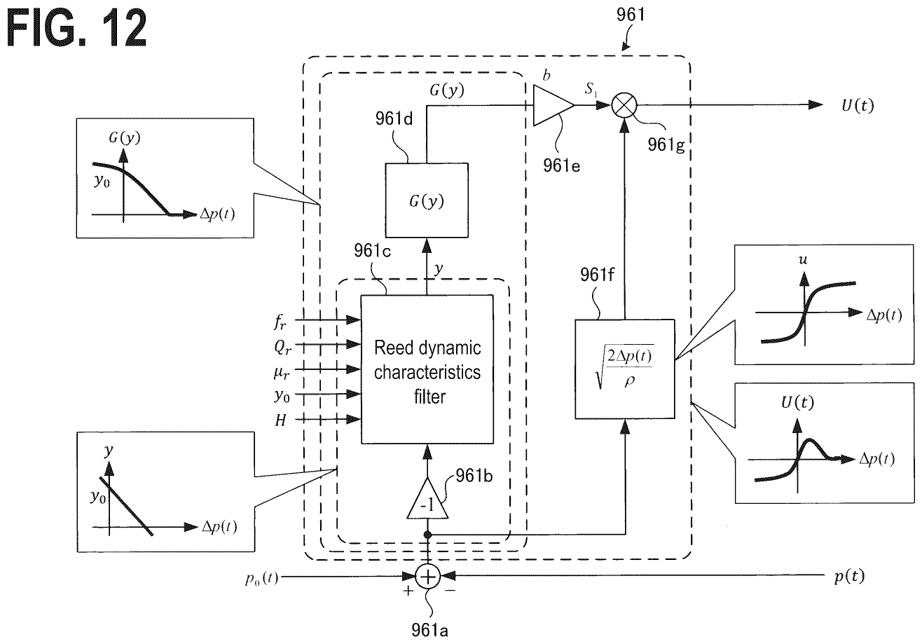

The physical model-based sound source module 96 computes a radiated sound waveform based on the signal output from the tube shape model estimator module 92b, the signal output from the second signal processor module 93, the signal output from the third signal processor module 94, and the signal output from the fourth signal processor module 95. The radiated sound waveform output from the physical model-based sound source module 96 is output to and amplified by an amplifier AM. The radiated sound waveform amplified by the amplifier AM is output to a speaker SP for conversion to a sound signal at the speaker SP. It should be understood that the speaker SP may be replaced with a headphone, an earphone, or any other such element. Now, the configuration and operation of the physical model-based sound source module 96 will be described with reference to FIGS. 11 and 12.

FIG. 11 is a block diagram of the configuration of the physical model-based sound source module 96. As illustrated in FIG. 11, the physical model-based sound source module 96 includes a reed dynamic characteristics block 961, a tube propagation realization block 962, an oral cavity propagation realization block 963, and a radiated propagation realization block 964.

FIG. 12 shows the configuration of the reed dynamic characteristics block 961. The reed dynamic characteristics block 961 contains a model pertaining to the dynamic characteristics of a single-reed configuration. As illustrated in FIG. 12, the reed dynamic characteristics block 961 includes a subtractor 961a, an inverter 961b, a reed dynamic characteristics filter sub-block 961c, a first computational sub-block 961d, a constant multiplier 961e, a second computational sub-block 961f, and a multiplier 961g.

The reed dynamic characteristics block 961 receives the blowing pressure signal p0(t), and a pressure signal p(t) immediately at the reed 4 as inputs. The subtractor 961a subtracts the pressure signal p(t) immediately at the reed 4 from the blowing pressure signal p0(t) to produce an output Δp(t), which corresponds to the differential between the blowing pressure signal p0(t) and the pressure signal p(t) immediately at the reed 4. The differential Δp(t) is fed as an input to the inverter 961b and the second computational sub-block 961f. The signal output from the inverter 961b is fed as an input to the reed dynamic characteristics filter sub-block 961c. The blowing pressure signal acquired by the fourth signal processor module 95 is associated with p0, which is fed as an input to an oral cavity-side waveguide model. It should be noted that, if the oral cavity propagation realization block is missing, the blowing pressure signal acquired by the fourth signal processor module 95 is associated with the blowing pressure signal p0(t), which is fed as an input to the reed dynamic characteristics block 961.

The resonant frequency fr of the reed 4, the Q factor Qr, the reed effective unit mass μr, the static opening degree y0 of the reed 4, and the initial value H of the static opening degree of the reed 4 are additionally fed as inputs to the reed dynamic characteristics filter sub-block 961c. The reed dynamic characteristics filter sub-block 961c serves as a digital filter, which uses the resonant frequency fr of the reed 4, the Q factor Qr, the reed effective unit mass μr, the static opening degree y0 of the reed 4, and the initial value H of the static opening degree of the reed 4 as parameters. In the instant example, a second-order IIR filter (or infinite impulse response filter) is used as the digital filter.

The output y from the reed dynamic characteristics filter sub-block 961c is equal to y0 when the differential value Δp(t) is zero and monotonically decreases with an increase in the blowing pressure signal p0(t).

The output y from the reed dynamic characteristics filter sub-block 961c is fed as an input to the first computational sub-block 961d. The first computational sub-block 961d produces an output G(y) as a computational result. The output G(y) is a function of a constrained displacement of the reed 4. The output G(y) makes little move along the y-axis when the differential value Δp(t) is in a range that indicates negative values. Further, the value of the output G(y) is clipped to zero if the y-coordinate value is in a range that indicates negative values. In other words, the output G(y) is equivalent to a value obtained by applying a minimum cap of zero on the value of y.

The output G(y) is fed as an input to the constant multiplier 961e. The constant multiplier 961e multiplies the output G(y) by b. This computation is analogous to calculating the area S1 occupied by the gap between the reed 4 and the mouthpiece 2. The coefficient b corresponds to the width at the tip end portion of the reed 4.

The second computational sub-block 961f computes and outputs the flow velocity u of air at the gap between the reed 4 and the mouthpiece 2 according to equation (3) as follows:

$$u = {( 2 \times Δ p ( t ) / ρ )}^{1 / 2} \qquad ( 3 )$$

The multiplier 961g multiplies the area S1 occupied by the gap between the reed 4 and the mouthpiece 2 by the flow velocity u and outputs the multiplication result, which is the volume flow velocity U(t) at the gap between the reed 4 and the mouthpiece 2.

Referring again to FIG. 11, the tube propagation realization block 962 contains a tube-side waveguide model 962a. The tube-side waveguide model 962a takes, as an input, tube shape information from the estimation by the tube shape model estimator module 92b. This results in the formation of the tube-side waveguide model. The tube propagation realization block 962 receives, from the reed dynamic characteristics block 961, the volume flow velocity U(t) at the gap between the reed 4 and the mouthpiece 2 as an input. The tube propagation realization block 962 feeds an output of the pressure signal p(t) immediately at the reed 4 to the reed dynamic characteristics block 961. The transfer function Zin(f) of the tube propagation realization block 962 is expressed as p(f)/U(f).

Further, the tube-side waveguide model 962a outputs a computation result, which is the sound pressure signal pout(t) at the bell outlet 3a, to the radiated propagation realization block 964.

The oral cavity propagation realization block 963 contains the oral cavity-side waveguide model 963a. The oral cavity-side waveguide model 963a takes, as an input, the oral cavity shape information from the estimation by the third signal processor moule 94. This results in the formation of the oral cavity-side waveguide model. The oral cavity propagation realization block 963 receives, from the reed dynamic characteristics block 961, the volume flow velocity U(t) as an input. The oral cavity propagation realization block 963 feeds an output of the blowing pressure signal p0(t) to the reed dynamic characteristics block 961.

The radiated propagation realization block 964 receives, as an input, the sound pressure signal pout(t) at the bell outlet 3a. The radiated propagation realization block 964 produces an output of a radiated sound pressure signal prad(t) based on the sound pressure signal pout(t) at the bell outlet 3a. For example, the radiated propagation realization block 964 is implemented with an IIR filter.

As such, the processor section 90 estimates the tube shape model based on the tone hole open/closed pattern estimated by the pattern estimator module 92a and computes a waveform pertaining to a radiated sound from the clarinet 1 based on the estimated tube shape model, the estimated state of change of the shape, characteristics, and/or other aspects of the reed 4, the estimated shape of the oral cavity, and the generated blowing pressure information. This configuration helps the physical model-based sound source module 96 handle embouchure-based changes in tone quality, involving a bend method, a flageolet method, and/or other such method. It should be noted that the processor section 90 estimates whether or not a bend method is being executed based on a strain of the reed 4 and estimates whether a flageolet method is being executed based on the shape of the oral cavity of the player.

As has been discussed thus far, a sensor device 20 in accordance with the aforementioned embodiment includes a first actuator 21 and a first sensor arrangement 31. The first actuator 21 is configured to generate a sound wave traveling within the tube 3 of a clarinet 1. The first sensor arrangement 31 includes a plurality of sensors 31a to 31h configured to sense the sound wave. The first actuator 21 and the first sensor arrangement 31 are configured to be arranged within the tube 3 such that the plurality of sensors 31a to 31h are positioned at a distance from one another in the longitudinal direction of the tube 3.

With the plurality of sensors 31a to 31h, a sensor device 20 in accordance with the aforementioned embodiment can determine the distribution of a standing wave appearing within the tube 3, with respect to sound pressure, to infer the open or closed state of each of a plurality of tone holes, that is, a tone hole open/closed pattern, from the distribution of the standing wave. Hence, a sensor device 20 in accordance with the aforementioned embodiment can determine the state of the clarinet 1 being played, with improved accuracy. More particularly, the inferred tone hole open/closed pattern allows for the acquisition of parameters necessary to compute a radiated sound waveform from the clarinet 1 with better precision. For example, play methods with different fingering in terms of a tone hole open/closed pattern can be distinguished from each other even when the produced sounds have the same frequency. In addition, since the plurality of sensors 31a to 31h are configured to be each positioned at a distance from one another in the longitudinal direction of the tube 3, a standing wave appearing within the tube 3 can be determined with better accuracy. For this reason, the tone hole open/closed pattern can be inferred with improved precision.

It should be understood that the clarinet 1 in the aforementioned embodiment represents an example of a “wind instrument” and the first actuator 21 represents an example of a “source”.

In addition, the sensor device 20 also includes a second actuator 22 and a second sensor arrangement 32. The second actuator 22 is configured to cause a reed 4 of the clarinet 1 to vibrate. The second sensor arrangement 32 includes a sensor configured to sense the vibrations of the reed 4. The second actuator 22 and the second sensor arrangement 32 are configured to be arranged on the reed 4.

This configuration allows the resonant characteristics of the reed 4 and the static opening degree of the reed 4 to be determined. Thus, it becomes possible to handle play methods that utilize different resonant characteristics and static opening degree of the reed 4 in producing sounds with different pitch and quality with the same tone hole open/closed pattern. Therefore, the state of the clarinet 1 being played can be determined with improved accuracy.

In addition, the sensor device 20 also includes a third actuator 23 and a third sensor arrangement 33. The third actuator 23 is configured to vibrate air in the oral cavity of a player who plays the clarinet 1. The third sensor arrangement 33 includes a sensor configured to sense when the air in the oral cavity vibrates. The third actuator 23 and the third sensor arrangement 33 are configured to be arranged within a mouthpiece 2 for the clarinet 1.

This configuration allows the shape of the oral cavity of the player to be determined. Thus, the state of the clarinet 1 being played can be determined with improved accuracy.

In addition, the sensor device 20 also includes a fourth sensor arrangement 34. The fourth sensor arrangement 34 includes a sensor configured to sense the blowing pressure of a player who plays the clarinet 1. The fourth sensor arrangement 34 is configured to be arranged within a mouthpiece 2 for the clarinet 1.

This configuration allows the blowing pressure of the player to be determined. Thus, the state of the clarinet 1 being played can be determined with improved accuracy.

In addition, the source is configured to vibrate air within the tube 3 of the clarinet 1 to generate the sound wave. The first actuator 21 is configured to vibrate air within the tube 3 of the clarinet 1 to generate the sound wave.

This configuration allows the sound wave traveling within the tube 3 to be sensed with each of the plurality of sensors 31a to 31h spaced apart at a distance from one another in the longitudinal direction of the tube 3. Since the sound wave traveling within the tube 3 manifests as a standing wave, each of the sensors 31a to 31h can sense a sound pressure level, which depends on the sound pressure distribution of the standing wave within the tube 3. The sound pressure distribution of the standing wave can be estimated from the sensing result of the sound pressure levels by the individual sensors 31a to 31h.

A sensor device 20 in accordance with the aforementioned embodiment includes a first actuator 21 and a first sensor arrangement 31. The first actuator 21 and the first sensor arrangement 31 are configured to be arranged within the tube 3. The first actuator 21 is configured to vibrate air within the tube 3 of the clarinet 1 to generate a sound wave. The first sensor arrangement 31 includes a plurality of sensors 31a to 31h to sense the sound wave.

In light of the fact that the sound wave traveling within the tube manifests as a standing wave, it is preferred to sense the sound wave at locations in proximity to the central axis C1 of the tube 3 in order to determine the sound pressure distribution of the standing wave. This allows a subset of the plurality of sensors 31a to 31h arranged within the tube 3, which are in closer proximity to the central axis C1 of the tube, to be selectively used when the first mount has been displaced off-axis. Thus, the sound pressure distribution of the standing wave can be determined with improved accuracy.

In addition, the plurality of sensors 31a to 31h are configured to be each positioned at a distance from one another in the longitudinal direction of the tube 3.

This arrangement of the plurality of sensors 31a to 31h, which are each spaced apart from one another in the longitudinal direction of the tube 3, allows the sound pressure distribution of the standing wave appearing within the tube 3 to be determined with improved accuracy.

A mute device 10 for a wind instrument in accordance with the aforementioned embodiment includes a sensor device 20 and a blocker device 50. The blocker device 50 is configured to be disposed between the tube 3 and a mouthpiece 2 for the clarinet 1 to block air from the mouthpiece 2 from flowing into the tube 3.

According to this configuration, the internal volume of the tube 3 does not communicate with the internal volume of the blocker device 50, which is configured to block air from the mouthpiece 2 from flowing into the tube 3. Accordingly, the air blown into the mouthpiece 2 by the player is prevented from flowing into the tube 3. Hence, the clarinet 1 is muted.

A method for computing a radiated sound waveform in accordance with the aforementioned embodiment includes estimating a tube shape model based on standing wave information and computing a waveform pertaining to a radiated sound from the clarinet 1 based on the estimated tube shape model and blowing pressure information. The standing wave information pertains to the distribution of the standing wave appearing within the tube 3 of the clarinet 1. The tube shape model represents the shape of the tube of the clarinet 1. The blowing pressure information pertains to the blowing pressure of a player who plays the clarinet 1.

This configuration allows the tube shape model to be derived from the sensed standing wave. The tube shape model enables estimation of pitch information and tone quality information from the shape of the tube, which depends on the fingering of the player on the clarinet 1, and, therefore, allows for computation of a sound waveform that reflects with better accuracy the state of the clarinet 1 being played. Furthermore, according to the foregoing configurations, the blowing pressure information is generated based on sensing of the blowing pressure of the player. Thus, based on the blowing pressure information, a sound waveform that matches the play timings of the player, the intensity increase and decrease of the blowing pressure, and/or other such property can be computed.

In addition, estimating the tube shape model includes receiving an input of the standing wave information to produce an output of a tone hole open/closed pattern in the clarinet 1 and deriving the tube shape model based on the output of the tone hole open/closed pattern. The tone hole open/closed pattern indicates a combination of the open or closed state of each of a plurality of tone holes.

According to this configuration, a tone hole open/closed pattern is estimated from the sensed standing wave, and the tube shape model is derived based on the estimated tone hole open/closed pattern. The tube shape model enables estimation of pitch information and tone quality information from the shape of the tube, which depends on the fingering of the player on the clarinet 1, and, therefore, allows for computation of a waveform that reflects with better accuracy the state of the clarinet 1 being played.

In addition, the standing wave contains a frequency in an audible band.

Waves in an audible band according to this configuration, that is, sound waves, are not susceptible to attenuation within the tube 3 and tend to manifest as a standing wave. Accordingly, estimation of the tone hole open/closed pattern involves generating a sound wave within the tube 3 and sensing the standing wave with the plurality of sensors. Further, the audible band coincides with the band in which sounds are emitted from the clarinet 1 and, therefore, helps the estimation of the tone hole open/closed pattern.

In addition, a method for computing a radiated sound waveform in accordance with the aforementioned embodiment includes estimating the state of change of the shape of the reed 4 based on reed vibrations information. Computing the waveform pertaining to the radiated sound includes computing the waveform based on the estimated tube shape model, the estimated state of change of the shape of the reed 4, and the generated blowing pressure information. The reed vibrations information pertains to the vibrations of the reed 4 of the clarinet 1.

According to this configuration, the resonant characteristics of the reed 4 and the static opening degree of the reed 4 are estimated from the detected vibrations information. This makes it possible to take into account whether or not a bend method is being executed by the player and, therefore, allows for computation of a sound waveform that reflects with better accuracy the state of the clarinet 1 being played.

In addition, a method for computing a radiated sound waveform in accordance with the aforementioned embodiment includes estimating the tube shape model using a trained model that is trained to provide a tone hole open/closed pattern OCP(i) as a function of standing wave sound pressure distribution information.

According to this configuration, in response to an input of the standing wave sound pressure distribution information, the trained model outputs the tone hole open/closed pattern OCP(i) that is associated with the standing wave sound pressure distribution information, and the tube shape model is estimated from the tone hole open/closed pattern OCP(i) output from the trained model. Hence, the need to develop a complicated program used to estimate the tone hole open/closed pattern OCP(i) from the standing wave sound pressure distribution information is obviated, thereby facilitating the estimation of the tube shape model. It should be noted that the standing wave sound pressure distribution information represents an example of “standing wave information”.

In addition, a method for computing a radiated sound waveform in accordance with the aforementioned embodiment includes estimating the shape of an oral cavity based on vibrations information and computing a waveform pertaining to a radiated sound from the clarinet 1 based on manipulation information, the estimated shape of the oral cavity, and blowing pressure information. The vibrations information pertains to the vibrations of air in the oral cavity of a player who plays the clarinet 1 having operators 6a to 6e. The manipulation information indicates the manipulation of the operators by the player. The blowing pressure information pertains to the blowing pressure of the player.

According to this configuration, the shape of the oral cavity of the player is estimated based on sensed vibrations of the air in the oral cavity. Accordingly, the state of the embouchure of the player as well as whether or not a flageolet method is being executed by the player can be taken into account, thereby allowing for computation of a sound waveform that reflects with better accuracy the state of the clarinet 1 being played. A flageolet method can produce sounds with different pitches despite the same tone hole open/closed pattern, by changing the shape of an oral cavity and the resonant characteristics of the oral cavity accordingly.

In addition, a method for computing a radiated sound waveform in accordance with the aforementioned embodiment includes outputting the waveform pertaining to the radiated sound as an electrical signal.

According to this configuration, a sound waveform, which reflects the state of the clarinet 1 being played, is output as an electrical signal, thus, allowing the player to use a speaker SP, a headphone, and/or other such tool to listen to the reproduced performance.

It should be noted that, while the tone hole open/closed pattern is estimated from the observed, sound pressure distribution of a standing wave in the aforementioned embodiment, an ultrasonic wave or an electromagnetic wave may be used as an alternative or in addition to the sound wave, such that the tone hole open/closed pattern may be estimated by observing the density distribution of a standing wave from ultrasonic waves or electromagnetic waves. It is more difficult to generate a standing wave from ultrasonic waves or electromagnetic waves within the tube 3. Yet, observation of the density distribution of the standing wave can be made possible by, for example, installing a reflector at the bell outlet and causing the reflector to create reflections. Accordingly, a reflector may be installed in the case of ultrasonic waves or electromagnetic waves.

Also, there may be a plurality of reflector plates within the tube 3. In case of electromagnetic waves, the plurality of reflector plates are preferably each made of metal. In case of ultrasonic waves, the plurality of reflector plates are preferably each circular, and any material can be used for each of the reflector plates. The plurality of reflector plates are preferably each installed immediately subsequent to a corresponding one of the tone holes. In this case, the plurality of sensors are preferably configured to be each installed immediately preceding and immediately subsequent to a corresponding one of the tone holes.

The phrase “immediately preceding a corresponding one of the tone holes” herein refers to a location between the corresponding tone hole and a tone hole immediately before the corresponding tone hole. Note that a tone hole immediately before the corresponding tone hole means a tone hole adjoining the corresponding tone hole on the side closer to the inlet of the tube 3 than the corresponding tone hole is. Further, the phrase “immediately subsequent to a corresponding one of the tone holes” refers to a location between the corresponding tone hole and a tone hole immediately after the corresponding tone hole. Note that a tone hole immediately after the corresponding tone hole means a tone hole adjoining the corresponding tone hole on the side closer to the outlet of the tube 3 than the corresponding tone hole is. Thus, a sensor installed immediately preceding a corresponding one of the tone holes and a sensor installed immediately subsequent to the corresponding tone hole would be positioned in the longitudinal direction of the tube 3 alternately with the corresponding tone hole. Further, each of the plurality of reflector plates preferably has such a diameter that leaves a gap in relation to the inner diameter of the tube 3 to allow ultrasonic waves or electromagnetic waves to be transmitted throughout the tube 3.

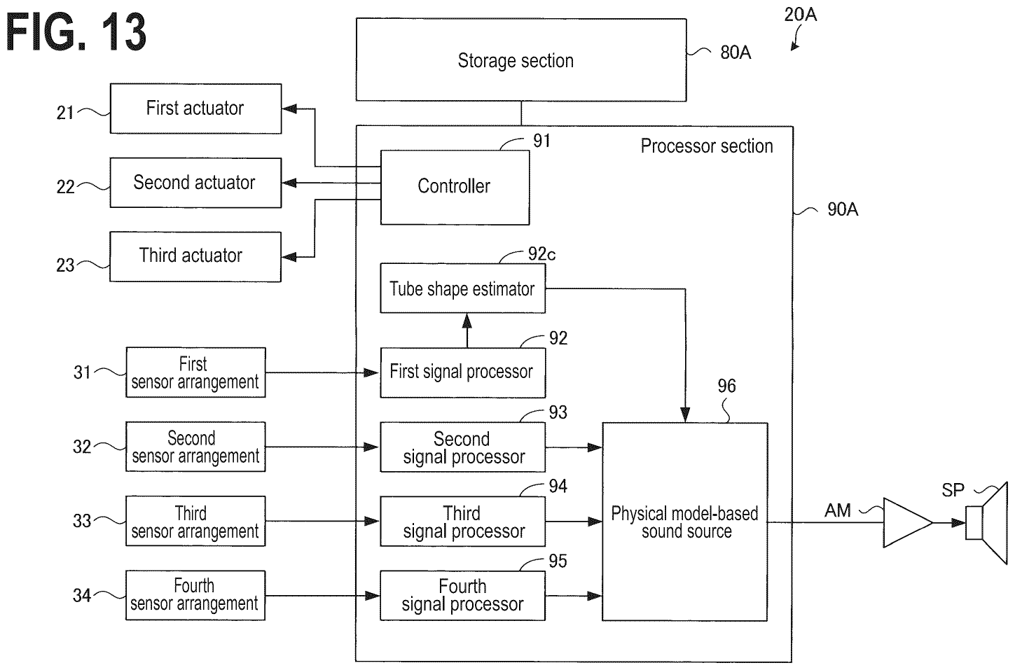

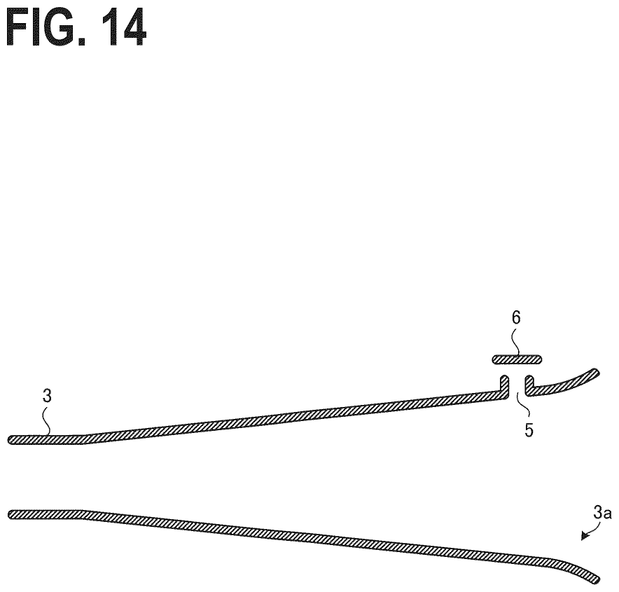

Now, a mute device for a wind instrument, a sensor device, and a method for computing a radiated sound waveform in accordance with a different embodiment of the present disclosure will be described with reference to FIGS. 13 and 14. It should be understood that, in the following discussion, parts identical to those from the aforementioned embodiment will be assigned with the same symbols from the aforementioned embodiment and the function of these parts will not be described for the sake of brevity. Moreover, the following discussions of embodiments will be largely centered around those features that differ from the aforementioned embodiment for the sake of clarity.

Now, referring to FIG. 13, the configuration of a sensor device in accordance with the different embodiment will be described. FIG. 13 is a block diagram of an example configuration of the sensor device, in accordance with the different embodiment. The sensor device 20A includes the first actuator 21, the second actuator 22, the third actuator 23, the first sensor arrangement 31, the second sensor arrangement 32, the third sensor arrangement 33, the fourth sensor arrangement 34, a storage section 80A, and a processor section 90A.

Just like the storage section 80, the storage section 80A is in the form of a computer-readable storage medium. The storage section 80A includes a non-volatile memory and a volatile memory. Examples of the non-volatile memory include a ROM, an EPROM, and an EEPROM. Examples of the volatile memory include a RAM.

A program p2 and various information are stored in the storage section 80A. The program p2 defines the operation of the sensor device 20A. The program p2 stored in the storage section 80A may be retrieved from a storage device in a server (not shown). In this case, the storage device in the server constitutes one of the non-limiting examples of the computer-readable storage medium. The storage section 80A differs from the storage section 80 in that the storage section 80A stores the program p2 instead of the program p1 and does not contain the tone hole open/closed pattern database 81, and is otherwise the same.

The processor section 90A includes one or more CPUs. The one or more CPUs constitute one of the non-limiting examples of one or more processors. Each of the processor section, the processor(s), and the CPU(s) constitutes one of the non-limiting examples of a computer.

The processor section 90A loads the program p2 from the storage section 80A. By executing the program p2, the processor section 90A implements the functions of the controller 91, the first signal processor module 92, a tube shape estimator module 92c, the second signal processor module 93, the third signal processor module 94, the fourth signal processor module 95, and the physical model-based sound source module 96. One or more of the controller 91, the first signal processor module 92, the tube shape estimator module 92c, the second signal processor module 93, the third signal processor module 94, the fourth signal processor module 95, and the physical model-based sound source module 96 may be implemented with a DSP, an ASIC, a PLD, a FPGA, or any other such circuit. The processor section 90A differs from the processor section 90 in that the processor section 90A implements the function of the tube shape estimator module 92c instead of implementing the functions of the pattern estimator module 92a and the tube shape model estimator module 92b, and is otherwise the same.

The tube shape estimator module 92c acquires amplitude information on the sound pressure levels at the individual sensors 31a to 31h from the first signal processor module 92. The tube shape estimator module 92c estimates the shape of the tube based on the amplitude information on the sound pressure levels at the individual sensors 31a to 31h.

An estimation model in the tube shape estimator module 92c is trained by using a machine learning process employing a regression technique, which will be further discussed below.

FIG. 14 is cross-sectional view of a simple physical model, in accordance with the different embodiment. While the clarinet 1 essentially has a tube that is shaped with a plurality of tone holes at fixed locations as shown in FIG. 1, the simple physical model illustrated in FIG. 14 assumes a tube that is shaped with a single tone hole 5 present at a variable longitudinal location and a bell outlet 3a having a variable distance to the single tone hole 5.

FIG. 14 depicts an operator 6 for opening and closing the single tone hole 5. When the single tone hole 5 is closed, the simple physical model simulates a state in which every single tone hole is closed. It should be understood that a state in which every single tone hole is closed may be described by the simple physical model as a state in which there is no tone hole.

For instance, the closest tone hole to the mouthpiece 2 among the open tone holes when at the pitch C4 in a real clarinet 1 is the tone hole No. 9, as shown in FIG. 5. To represent, with the simple physical model, a shape capable of emitting sounds at the pitch C4, the single tone hole would be opened at the location corresponding to the tone hole No. 9 while accordingly adjusting the location of the bell outlet.

The locations of the tone hole and the bell outlet to allow sounds to be emitted at the pitch C4 are given in the form of parameters that take continuous values. In the different embodiment, the combination of the locations of the tone hole and the bell outlet, on one hand, and the corresponding pitch C4, on the other hand, is prepared in advance so as to be provided as output data for a neural network-based trained model. The locations of the tone hole and the bell outlet represent characteristic shape parameters of the simple physical model. The locations of the tone hole and the bell outlet will hereinafter be referred to model shape parameters. The model shape parameters vs. corresponding pitch combinations are also prepared for the other pitches in advance, so as to be likewise provided as output data for the neural network-based trained model.

A machine learning apparatus with the neural network-based model feeds the standing wave sound pressure distribution information I1 to In as input data to the neural network model, in order to train the neural network model to provide the model shape parameters, which serve as output data, as a function of the standing wave sound pressure distribution information I1 to In, which serve as input data.

More particularly, the machine learning apparatus feeds, as input data, the standing wave sound pressure distribution information I1 (L1(1), L2(1), . . . , Lm(1)), . . . , and In (L1(n), L2(n), . . . , Lm(n)) constituting the training data, to an input layer of the neural network.

The machine learning apparatus uses an evaluation function, which compares the output data produced as an inference result from an output layer of the neural network-namely, the model shape parameters for a pitch associated with the standing wave sound pressure distribution information I1 to In—against the output data (that is, model shape parameters) constituting the training data, to adjust the weights assigned to synapses in an iterative manner until the value of the evaluation function is sufficiently minimized. The process of making adjustments to the weights assigned to the synapses in this context is called backpropagation.

The machine learning apparatus ends the machine learning process upon determining that a prescribed condition for completing the training has been met and stores the neural network model as of this point in the storage section 80A as a trained model. For example, the prescribed condition for completing the training is that the number of iterations of the training process with the abovementioned set of steps reaches a predefined threshold and that the value of the evaluation function drops below an acceptable level.

The present disclosure is not limited to the foregoing embodiments and leaves room for numerous variants that can be adopted within the scope of the present disclosure. Particular variants will be discussed below by way of example. Also, two or more of the variants discussed below may be selected as desired and combined as appropriate, to the extent that these variants do not conflict each other. It should be noted that, in the variants discussed below, parts equivalent to those from the preceding embodiments in terms of action and/or function are indicated with the symbols used in the foregoing description and will not be discussed in detail where appropriate.

While the plurality of sensors of the first sensor arrangement 31 are configured to be positioned at a distance from one another in the longitudinal direction of the tube 3 in the preceding embodiments, the plurality of sensors may additionally or alternatively be configured to be positioned at a distance in the circumferential direction of the tube 3.

Ideally, the sound pressure distribution of a standing wave appearing within the tube 3 is sensed along the central axis C1 of the tube 3. By positioning the plurality of sensors in the circumferential direction, a subset of the sensors, which are in closer proximity to the central axis C1, can be selectively used to achieve better sensing of the standing wave when the fixing locations of the sensors have been displaced for unknown reasons. Also, in case there is a protrusion or other such obstacle within the tube 3, a subset of the sensors that are less affected by the obstacle can be selectively used to achieve better sensing of the standing wave.

While the first actuator 21 is configured to generate a wave in an audible band, which is a frequency band in the range of 20 Hz to 20 kHz, in the preceding embodiments, the first actuator 21 may be configured to generate an ultrasonic wave in a frequency band that is higher than the audible band. Examples of an actuator that can be used to generate an ultrasonic wave include a piezoelectric element. Further, in this case, piezoelectric elements may be used as the plurality of sensors of the first sensor arrangement 31.

When compared to sound waves, ultrasonic waves are more susceptible to attenuation within the tube 3. Accordingly, an ultrasonic wave is attenuated as the wave travels from the position of the first actuator 21 towards the bell outlet 3a, resulting in a limited component of the wave being reflected at the bell outlet 3a. Thus, an ultrasonic wave tends to be observed as a progressive wave within the tube 3. Further, ultrasonic waves are easily attenuated by open tone holes. For these reasons, the plurality of sensors may be configured to be positioned at a distance in the longitudinal direction of the tube 3 within the tube 3 and have the intensity of an ultrasonic wave sensed by these various sensors to provide a measurement of the attenuation pattern of the ultrasonic wave.

The attenuation pattern of the ultrasonic wave is influenced by the open or closed state of each of the tone holes. Hence, the tone hole open/closed pattern can be estimated from the attenuation pattern of the ultrasonic wave. As such, the plurality of sensors configured to be positioned at a distance in the longitudinal direction of the tube 3 within the tube 3 can be used to provide a measurement of the attenuation pattern of an ultrasonic wave, thereby improving the precision with which the tone hole open/closed pattern is estimated. Further, due to the fact that no audible sound is emitted in the instant variant, a sensor device 20 according to the instant variant, when applied to the mute device 10 for the wind instrument, allows the player to play the clarinet 1 with a reduced volume of sounds being emitted to the surroundings of the clarinet 1.

The sensors are preferably configured to be each positioned as close to a corresponding one of the tone holes as possible. Further, at least one of the plurality of sensors is preferably configured to be positioned at the bell outlet 3a.

Note that, as discussed earlier, observation of the density distribution of a standing wave from ultrasonic waves can be made possible by installing one or more reflectors at the outlet of the tube 3 and/or within the tube 3. Then, a sensor device in accordance with the instant variant can also be used to determine the density distribution of a standing wave from ultrasonic waves.

While the first actuator 21 configured to vibrate air within the tube 3 is used as a source of a wave traveling within the tube 3 in the preceding embodiments, an oscillator and antenna that are configured to generate an electromagnetic wave may be used as the source. Moreover, in this case, a plurality of antennas may be used as the plurality of sensors of the first sensor arrangement 31.

Just like ultrasonic waves, electromagnetic waves are more susceptible to attenuation within the tube 3. Thus, an electromagnetic wave tends to be observed as a progressive wave within the tube 3. Further, electromagnetic waves are easily attenuated by open tone holes. For these reasons, the plurality of sensors may be configured to be positioned at a distance in the longitudinal direction of the tube 3 within the tube 3 and have the wave intensity of an electromagnetic wave sensed by these various sensors to provide a measurement of the attenuation pattern of the electromagnetic wave.

The attenuation pattern of the electromagnetic wave is influenced by the open or closed state of each of the tone holes. Hence, the tone hole open/closed pattern can be estimated from the attenuation pattern of the electromagnetic wave. As such, the plurality of sensors configured to be positioned at a distance in the longitudinal direction of the tube 3 within the tube 3 can be used to provide a measurement of the attenuation pattern of an electromagnetic wave, thereby improving the precision with which the tone hole open/closed pattern is estimated. Further, due to the fact that no audible sound is emitted in the instant variant, a sensor device 20 according to the instant variant, when applied to the mute device 10 for the wind instrument, allows the player to play the clarinet 1 with a reduced volume of sounds being emitted to the surroundings of the clarinet 1. It should be noted that, in this case, the output of the source should preferably be 100 mW/cm2 or less in consideration of the effect of electromagnetic waves on a human body (https://acoustics.jp/qanda/answer/78.html).

Note that, as discussed earlier, observation of the density distribution of a standing wave from electromagnetic waves can be made possible by installing one or more reflectors at the outlet of the tube 3 and/or within the tube 3. Then, a sensor device in accordance with the instant variant can also be used to determine the density distribution of a standing wave from electromagnetic waves.

The level of attenuation of a progressive wave in an audible band may be observed to estimate the tone hole open/closed pattern based on progressive wave information. The progressive wave information pertains to the distribution of a progressive wave. For example, while a progressive wave in an audible band is relatively hard to be attenuated, the progressive wave tends to be easily attenuated after traveling past an open tone hole. Thus, the open or closed state of each of the tone holes can be discriminated by installing the sensors of the first sensor arrangement 31 at the locations immediately preceding and immediately subsequent to the individual tone holes and comparing the respective outputs from the installed sensors.

For instance, a tone hole of interest may be determined to be open when, from a comparison between the output of a sensor immediately preceding the tone hole of interest and the output of a sensor immediately subsequent to the tone hole of interest, the output of the immediately subsequent sensor is found to be greater than the output of the immediately preceding sensor and the differential between the outputs of the immediately subsequent sensor and the immediately preceding sensor is equal to or greater than a certain value. The immediately preceding sensor refers to a sensor arranged at a location immediately preceding the tone hole of interest. The immediately subsequent sensor refers to a sensor arranged at a location immediately subsequent to the tone hole of interest. The immediately preceding sensor and the immediately subsequent sensor are configured to be positioned alternately with the tone hole of interest.

Since the open or closed state of each of the tone holes can be discriminated by comparing the outputs of the immediately preceding sensor and the immediately subsequent sensor, the instant configuration eliminates the need to use a machine learning apparatus to estimate the tone hole open/closed pattern. Thus, the tone hole open/closed pattern can be estimated with a simpler configuration.

In the preceding embodiments, the second actuator 22 is used to cause the reed 4 to vibrate so that the vibrations of the reed 4 can be sensed using the second sensor arrangement 32. While a contact vibration sensor such as a piezoelectric element and an acceleration sensor or a non-contact vibration sensor such as a photocoupler is employed for the second sensor arrangement 32, a strain sensor may alternatively or additionally be used to sense the displacement of the reed 4. When a strain sensor is used, it is not necessary to cause the reed 4 to vibrate, thus, obviating the need for the second actuator 22.

In one of the preceding embodiments, the tube shape model is estimated based on the tone hole open/closed pattern estimated by the pattern estimator module 92a so that the radiated sound wave form can be computed by the physical model-based sound source module 96 based on the estimated tube shape model. Meanwhile, in the different embodiment, the radiated sound waveform is computed by the physical model-based sound source module 96 based on the shape of the tube as estimated by the tube shape estimator module 92c. In contrast, in one variant, a pitch may be determined based on the estimated tube shape model or the estimated shape of the tube, and a PCM (or pulse code modulation)-based sound source module may be used in place of the physical model-based sound source module 96 to have a stored waveform corresponding to the pitch replayed as the radiated sound waveform.

It should be noted that a mute device for a wind instrument in accordance with the instant variant may include both the physical model-based sound source module 96 and the PCM-based sound source module. For example, the mute device for the wind instrument may be configured to allow a player to select whether to compute the radiated sound waveform using the physical model-based sound source module 96 or compute the radial sound waveform using the PCM-based sound source module.

While the clarinet 1 is used to illustrate an example of the wind instrument in the preceding embodiments, a different reed instrument such as an oboe, a saxophone, or bassoon may be used as the wind instrument. It should be noted that, for double-reed instruments like bassoon, the model pertaining to the dynamic characteristics of single-reed configurations employed in the reed dynamic characteristics block 961 can be replaced with a model pertaining to the dynamic characteristics of double-reed configurations.

From the configurations presented above by way of example, the following example implementations can be conceived:

A sensor device according to one of the implementations of the present disclosure includes a source and a first sensor arrangement. The source is configured to generate a wave traveling within a tube of a wind instrument. The first sensor arrangement includes a plurality of sensors configured to sense the wave. The source and the first sensor arrangement are configured to be arranged within the tube such that the plurality of sensors are each positioned at a distance from one another in the longitudinal direction of the tube.

According to this implementation, the provision of the plurality of sensors allows for determination of the distribution of a standing wave appearing within the tube, and the distribution of the standing wave can be used to infer the open or closed state of each of the plurality of tone holes. The inference result for the open or closed states of the plurality of tone holes is used to determine a pitch. This mechanism makes the determination result less sensitive to the nature of the aspects of resonance, like one pitch having a resonance intensity weaker than that of a different pitch during the course of a fingering effort. Accordingly, incorrect determination of pitches can be avoided. In addition, since the plurality of sensors are configured to be each positioned at a distance from one another in the longitudinal direction of the tube, a standing wave appearing within the tube can be determined with better accuracy. For this reason, pitches can be determined with improved precision.

A sensor device according to one of the implementations of the present disclosure further includes a second actuator and a second sensor arrangement. The second actuator is configured to cause a reed of the wind instrument to vibrate. The second sensor arrangement includes at least one sensor configured to sense the vibrations of the reed. The second actuator and the second sensor arrangement are configured to be arranged on the reed.

This implementation allows the resonant characteristics of the reed and the static opening degree of the reed to be determined. Therefore, the state of the wind instrument being played can be determined with improved accuracy.

A sensor device according to one of the implementations of the present disclosure further includes a third actuator and a third sensor arrangement. The third actuator is configured to vibrate air in the oral cavity of a player who plays the wind instrument. The third sensor arrangement includes at least one sensor configured to sense when the air in the oral cavity vibrates. The third actuator and the third sensor arrangement are configured to be arranged within a mouthpiece for the wind instrument.

This implementation allows the shape of the oral cavity of the player to be determined. Thus, the state of the wind instrument being played can be determined with improved accuracy.

A sensor device according to one of the implementations of the present disclosure further includes a fourth sensor arrangement. The fourth sensor arrangement includes at least one sensor configured to sense the blowing pressure of a player who plays the wind instrument. The fourth sensor arrangement is configured to be arranged within a mouthpiece for the wind instrument.

This implementation allows the blowing pressure of the player to be determined. Thus, the state of the wind instrument being played can be determined with improved accuracy.

In a sensor device according to one of the implementations of the present disclosure: the source includes a first actuator configured to vibrate air within the tube of the wind instrument to generate a sound wave; and each of the plurality of sensors is configured to sense the sound wave.

This implementation allows the sound wave traveling within the tube to be sensed with each of the plurality of sensors spaced apart at a distance from one another in the longitudinal direction of the tube. Since the sound wave traveling within the tube manifests as a standing wave, each of the sensors can sense the sound pressure level, which depends on the sound pressure distribution of the standing wave within the tube. The sound pressure distribution of the standing wave can be estimated from the sensing result of the sound pressure levels by the individual sensors.

A sensor device according to one of the implementations of the present disclosure includes a first actuator, a first sensor arrangement, and a first mount. The first actuator is configured to vibrate air within the tube of a wind instrument to generate a sound wave. The first sensor arrangement includes a plurality of sensors configured to sense the sound wave. The first mount is configured to dispose the first actuator and the first sensor arrangement within the tube.

In light of the fact that the sound wave traveling within the tube manifests as a standing wave, it is preferred to sense the sound wave at locations in proximity to the central axis of the tube in order to determine the sound pressure distribution of the standing wave. This allows a subset of the plurality of sensors arranged within the tube 3, which are in closer proximity to the central axis of the tube, to be selectively used when the first mount has been displaced off-axis. Thus, the sound pressure distribution of the standing wave can be determined with improved accuracy.

In a sensor device according to one of the implementations of the present disclosure, the plurality of sensors are configured to be each positioned at a distance from one another in the longitudinal direction of the tube.

This arrangement of the plurality of sensors, which are each spaced apart from one another in the longitudinal direction of the tube, allows the sound pressure distribution of the standing wave appearing within the tube to be determined with improved accuracy.

In a sensor device according to one of the implementations of the present disclosure: the wind instrument includes one or more tone holes; and the plurality of sensors are configured to be positioned in the longitudinal direction alternately with the tone holes.

According to this implementation, the plurality of sensors are configured to be each positioned immediately preceding and immediately subsequent to the tone holes. Since the open or closed state of each of the tone holes can be discriminated by comparing the outputs of the immediately preceding sensor and the immediately subsequent sensor, the instant implementation eliminates the need to use a machine learning apparatus to estimate the tone hole open/closed pattern. Thus, the tone hole open/closed pattern can be estimated with a simpler configuration.

A mute device for a wind instrument according to one of the implementations of the present disclosure includes a sensor device according to any one of the aforementioned implementations and a blocker device. The blocker device is configured to be disposed between the tube and a mouthpiece for the wind instrument to block air from the mouthpiece from flowing into the tube.

According to this implementation, the internal volume of the tube does not communicate with the internal volume of the blocker device, which is configured to block air from the mouthpiece from flowing into the tube. Accordingly, the air blown into the mouthpiece by the player is prevented from flowing into the tube. Hence, the wind instrument is muted.

A method for computing a radiated sound waveform according to one of the implementations of the present disclosure includes estimating a tube shape model representing the shape of the tube of a wind instrument based on standing wave information pertaining to the distribution of a standing wave appearing within the tube of the wind instrument. The method also includes computing a waveform pertaining to a radiated sound from the wind instrument based on the estimated tube shape model and blowing pressure information pertaining to the blowing pressure of a player who plays the wind instrument.

This implementation allows the tube shape model to be derived from the sensed standing wave. The tube shape model enables estimation of pitch information and tone quality information from the shape of the tube, which depends on the fingering of the player on the wind instrument, and, therefore, allows for computation of a sound waveform that reflects with better accuracy the state of the wind instrument being played. Furthermore, according to the instant implementation, the blowing pressure information is generated based on sensing of the blowing pressure of the player. Thus, based on the blowing pressure information, a sound waveform that matches the play timings of the player, the intensity increase and decrease of the blowing pressure, and/or other such property can be computed.

In a method for computing a radiated sound waveform according to one of the implementations of the present disclosure, estimating the tube shape model includes receiving an input of the standing wave information to produce an output of a tone hole open/closed pattern indicating a combination of the open or closed state of each of a plurality of tone holes in the wind instrument, and deriving the tube shape model based on the output of the tone hole open/closed pattern.

According to this implementation, a tone hole open/closed pattern is estimated from the sensed standing wave, and the tube shape model is derived based on the estimated tone hole open/closed pattern. The tube shape model enables estimation of pitch information and tone quality information from the shape of the tube, which depends on the fingering of the player on the wind instrument, and, therefore, allows for computation of a sound waveform that reflects with better accuracy the state of the wind instrument being played.

In a method for computing a radiated sound waveform according to one of the implementations of the present disclosure, the standing wave contains a frequency in an audible band.

Waves in an audible band according to this implementation, that is, sound waves are not susceptible to attenuation within the tube and tend to manifest as a standing wave. Accordingly, the tone hole open/closed pattern can be estimated by generating a sound wave within the tube and sensing the consequent standing wave with the plurality of sensors.

In a method for computing a radiated sound waveform according to one of the implementations of the present disclosure, estimating the tube shape model includes using a trained model that is trained to provide a tone hole open/closed pattern indicating a combination of the open or closed state of each of a plurality of tone holes in the wind instrument as a function of the standing wave information.

According to this implementation, in response to an input of the standing wave information, the trained model outputs the tone hole open/closed pattern that is associated with the standing wave information, and the tube shape model is estimated from the tone hole open/closed pattern output from the trained model. Hence, the need to develop a complicated program used to estimate the tone hole open/closed pattern from the standing wave information is obviated, thereby facilitating the estimation of the tube shape model.

A method for computing a radiated sound waveform according to one of the implementations of the present disclosure includes estimating a tube shape model representing the shape of the tube of a wind instrument based on progressive wave information pertaining to the distribution of a progressive wave appearing within the tube of the wind instrument. The method also includes computing a waveform pertaining to a radiated sound from the wind instrument based on the estimated tube shape model and blowing pressure information pertaining to the blowing pressure of a player who plays the wind instrument.

This implementation allows the tube shape model to be derived from the sensed progressive wave. The tube shape model enables estimation of pitch information and tone quality information from the shape of the tube, which depends on the fingering of the player on the wind instrument, and, therefore, allows for computation of a sound waveform that reflects with better accuracy the state of the wind instrument being played. Furthermore, according to the instant implementation, the blowing pressure information is generated based on sensing of the blowing pressure of the player. Thus, based on the blowing pressure information, a sound waveform that matches the play timings of the player, the intensity increase and decrease of the blowing pressure, and/or other such property can be computed.

In a method for computing a radiated sound waveform according to one of the implementations of the present disclosure, estimating the tube shape model includes receiving an input of the progressive wave information to produce an output of a tone hole open/closed pattern indicating a combination of the open or closed state of each of a plurality of tone holes in the wind instrument, and deriving the tube shape model based on the output of the tone hole open/closed pattern.

According to this implementation, a tone hole open/closed pattern is estimated from the sensed progressive wave, and the tube shape model is derived based on the estimated tone hole open/closed pattern. The tube shape model enables estimation of pitch information and tone quality information from the shape of the tube, which depends on the fingering of the player on the wind instrument, and, therefore, allows for computation of a sound waveform that reflects with better accuracy the state of the wind instrument being played.

In a method for computing a radiated sound waveform according to one of the implementations of the present disclosure, the progressive wave contains a frequency at or greater than an ultrasonic band.

Waves in or above an ultrasonic band are more susceptible to attenuation within the tube and tend to manifest as a progressive wave, according to this implementation. Accordingly, the tone hole open/closed pattern can be estimated by generating an ultrasonic wave or an electromagnetic wave within the tube and sensing the consequent progressive wave with the plurality of sensors.

A method for computing a radiated sound waveform according to one of the implementations of the present disclosure further includes estimating the state of change of the shape of a reed of the wind instrument based on reed vibrations information pertaining to the vibrations of the reed. Computing the waveform pertaining to the radiated sound includes computing the waveform based on the estimated tube shape model, the estimated state of change of the shape of the reed, and the generated blowing pressure information.

According to this implementation, the resonant characteristics of the reed and the static opening degree of the reed are estimated from the detected vibrations information. This makes it possible to estimate whether or not a bend method is being executed by the player and, therefore, allows for computation of a sound waveform that reflects with better accuracy the state of the wind instrument being played.

A method for computing a radiated sound waveform according to one of the implementations of the present disclosure includes estimating the shape of the oral cavity of a player who plays a wind instrument having an operator based on vibrations information pertaining to the vibrations of air in the oral cavity. The method also includes computing a waveform pertaining to a radiated sound from the wind instrument based on manipulation information indicating manipulation of the operator by the player, the estimated shape of the oral cavity, and blowing pressure information pertaining to the blowing pressure of the player.

According to this configuration, the shape of the oral cavity of the player is estimated based on sensed vibrations of the air in the oral cavity. Accordingly, the state of the embouchure of the player as well as whether or not a flageolet method is being executed by the player can be estimated, thereby allowing for computation of a sound waveform that reflects with better accuracy the state of the wind instrument being played.

In a method for computing a radiated sound waveform according to one of the implementations of the present disclosure, computing the waveform pertaining to the radiated sound includes determining a pitch based on the manipulation information, the shape of the oral cavity, and the blowing pressure information to use a stored waveform corresponding to the determined pitch as the waveform pertaining to the radiated sound.

According to this implementation, a pitch is determined based on the information on manipulation of the wind instrument by a player, the shape of the oral cavity of the player, and the information on the blowing pressure of the player. By providing a PCM-based sound source that includes stored waveforms corresponding to different pitches, the radiated sound waveform can also be computed based on the waveforms corresponding to the different pitches stored in the PCM-based sound source.

A method for computing a radiated sound waveform according to one of the implementations of the present disclosure further includes outputting the waveform pertaining to the radiated sound as an electrical signal.

According to this implementation, a sound waveform, which reflects the state of the wind instrument being played, is output as an electrical signal, thus, allowing the player to use a speaker and/or a headphone to listen to the reproduced performance.

A mute device for a wind instrument according to one of the implementations of the present disclosure includes a sensor device according to any one of the aforementioned implementations, a blocker device, and a processor section. The blocker device is configured to be disposed between the tube and a mouthpiece for the wind instrument to block air from the mouthpiece from flowing into the tube. The processor section includes a pattern estimator module configured to estimate a tone hole open/closed pattern indicating a combination of the open or closed state of each of a plurality of tone holes of the wind instrument based on a sensing result of the first sensor arrangement, a reed state estimator module configured to estimate the state of change of the shape of the reed based on a sensing result of the second sensor arrangement, an oral cavity shape estimator module configured to estimate the shape of an oral cavity based on a sensing result of the third sensor arrangement, and a blowing pressure information generator module configured to generate blowing pressure information pertaining to a blowing pressure based on a sensing result of the fourth sensor arrangement. The processor section is configured to estimate a tube shape model based on the tone hole open/closed pattern estimated by the pattern estimator module and compute a waveform pertaining to a radiated sound from the wind instrument based on the estimated tube shape model, the estimated state of change of the shape of the reed, the estimated shape of the oral cavity, and the generated blowing pressure information.

According to this implementation, a tone hole open/closed pattern is estimated, and a tube shape model is derived based on the estimated tone hole open/closed pattern. Also, according to this implementation, the resonant characteristics of the reed, the static opening degree of the reed, and the shape of the oral cavity of the player are estimated. Further, according to this implementation, a sound waveform that matches the play timings of the player, the intensity increase and decrease of the blowing pressure, and/or other such property is computed based on the blowing pressure information. Accordingly, the state of the embouchure of the player, as well as whether or not a bend method is being executed by the player and whether or not a flageolet method is being executed by the player can be estimated, thereby allowing for computation of a sound waveform that reflects with better accuracy the state of the wind instrument being played.

While embodiments of the present disclosure have been described, the embodiments are intended as illustrative only and are not intended to limit the scope of the present disclosure. It will be understood that the present disclosure can be embodied in other forms without departing from the scope of the present disclosure, and that other omissions, substitutions, additions, and/or alterations can be made to the embodiments. Thus, these embodiments and modifications thereof are intended to be encompassed by the scope of the present disclosure. The scope of the present disclosure accordingly is to be defined as set forth in the appended claims.

What is claimed is:

1. A sensor device comprising:
a source configured to generate a wave traveling within a tube of a wind instrument; and
a first sensor arrangement including a plurality of sensors configured to sense the wave, the source and the first sensor arrangement being configured to be arranged within the tube such that the plurality of sensors are each positioned at a distance from one another in a longitudinal direction of the tube.

2. The sensor device according to claim 1, further comprising:
a second actuator configured to cause a reed of the wind instrument to vibrate; and
a second sensor arrangement including at least one sensor configured to sense vibrations of the reed, the second actuator and the second sensor arrangement being configured to be arranged on the reed.

3. The sensor device according to claim 1, further comprising:
a third actuator configured to cause air in an oral cavity of a player of the wind instrument to vibrate; and
a third sensor arrangement including at least one sensor configured to detect vibration of the air in the oral cavity,
wherein the third actuator and the third sensor arrangement are configured to be disposed within a mouthpiece of the wind instrument.

4. The sensor device according to claim 1, further comprising:
a fourth sensor arrangement including at least one sensor configured to sense a blowing pressure of a player who plays the wind instrument, the fourth sensor arrangement being configured to be arranged within a mouthpiece for the wind instrument.

5. The sensor device according to claim 1, wherein:
the source comprises a first actuator configured to vibrate air within the tube of the wind instrument to generate a sound wave; and
each of the plurality of sensors is configured to sense the sound wave.

6. A sensor device comprising:
a first actuator configured to vibrate air within a tube of a wind instrument to generate a sound wave;
a first sensor arrangement including a plurality of sensors configured to sense the sound wave; and
a first mount configured to dispose the first actuator and the first sensor arrangement within the tube.

7. The sensor device according to claim 6, wherein the plurality of sensors are configured to be each positioned at a distance from one another in a longitudinal direction of the tube.

8. The sensor device according to claim 1, wherein:
the wind instrument includes one or more tone holes; and
the plurality of sensors are configured to be positioned in the longitudinal direction alternately with the tone holes.

9. A mute device for a wind instrument, the device comprising:
a sensor device according to claim 1; and
a blocker device configured to be disposed between the tube and a mouthpiece for the wind instrument to block air from the mouthpiece from flowing into the tube.

10. A method for computing a radiated sound waveform, the method comprising:
estimating a tube shape model representing a shape of a tube of a wind instrument based on standing wave information pertaining to a distribution of a standing wave appearing within the tube of the wind instrument; and
computing a waveform pertaining to a radiated sound from the wind instrument based on the estimated tube shape model and blowing pressure information pertaining to a blowing pressure of a player who plays the wind instrument.

11. The method according to claim 10, wherein estimating the tube shape model comprises receiving an input of the standing wave information to produce an output of a tone hole open/closed pattern indicating a combination of an open or closed state of each of a plurality of tone holes in the wind instrument, and deriving the tube shape model based on the output of the tone hole open/closed pattern.

12. The method according to claim 10, wherein the standing wave contains a frequency in an audible band.

13. The method according to claim 10, wherein estimating the tube shape model comprises using a trained model that is trained to provide a tone hole open/closed pattern indicating a combination of an open or closed state of each of a plurality of tone holes in the wind instrument as a function of the standing wave information.

14. A method for computing a radiated sound waveform, the method comprising:
estimating a tube shape model representing a shape of a tube of a wind instrument based on progressive wave information pertaining to a distribution of a progressive wave appearing within the tube of the wind instrument; and
computing a waveform pertaining to a radiated sound from the wind instrument based on the estimated tube shape model and blowing pressure information pertaining to a blowing pressure of a player who plays the wind instrument.

15. The method according to claim 14, wherein estimating the tube shape model comprises receiving an input of the progressive wave information to produce an output of a tone hole open/closed pattern indicating a combination of an open or closed state of each of a plurality of tone holes in the wind instrument, and deriving the tube shape model based on the output of the tone hole open/closed pattern.

16. The method according to claim 13, wherein the progressive wave contains a frequency at or greater than an ultrasonic band.

17. The method according to claim 10, the method further comprising:
estimating a state of change of a shape of a reed of the wind instrument based on reed vibrations information pertaining to vibrations of the reed,
wherein computing the waveform pertaining to the radiated sound comprises computing the waveform based on the estimated tube shape model, the estimated state of change of the shape of the reed, and the generated blowing pressure information.

18. A method for computing a radiated sound waveform, the method comprising:
estimating a shape of an oral cavity of a player who plays a wind instrument having an operator based on vibrations information pertaining to vibrations of air in the oral cavity; and
computing a waveform pertaining to a radiated sound from the wind instrument based on manipulation information indicating manipulation of the operator by the player, the estimated shape of the oral cavity, and blowing pressure information pertaining to a blowing pressure of the player.

19. The method according to claim 18, wherein computing the waveform pertaining to the radiated sound comprises determining a pitch based on the manipulation information, the shape of the oral cavity, and the blowing pressure information to use a stored waveform corresponding to the determined pitch as the waveform pertaining to the radiated sound.

20. The method according to claim 10, further comprising:
outputting the waveform pertaining to the radiated sound as an electrical signal.
